(19) United States
(12) Patent Application Publication
(10) Pub. No.: US 2014/0244909 A1
(43) Pub. Date: Aug. 28, 2014

(54) SEMICONDUCTOR MEMORY DEVICE

(71) Applicant: Kabushiki Kaisha Toshiba, Minato-ku (JP)

(72) Inventors: Masanobu Shirakawa, Kanagawa-ken (JP); Koji Hosono, Kanagawa-ken (JP)

(73) Assignee: Kabushiki Kaisha Toshiba, Minato-ku (JP)

(21) Appl. No.: 14/168,164

(22) Filed: Jan. 30, 2014

(30) Foreign Application Priority Data
Feb. 27, 2013 (JP) 2013-037107

(51) Int. Cl. G06F 12/02

(52) U.S. Cl. CPC G06F 12/0246
USPC 711/103

(57) ABSTRACT

According to one embodiment, a semiconductor memory device includes: string units including a plurality of memory cells stacked above a semiconductor substrate; and a control circuit configured to perform an erase operation per a block, the block including the string units, the control circuit being configured to perform an erase verify operation per string unit.

### CROSS-REFERENCE TO RELATED APPLICATION

This application is based upon and claims the benefit of priority from Japanese Patent Application No. 2013-037107, filed Feb. 27, 2013, the entire contents of which are incorporated herein by reference.

### FIELD

Embodiments described herein relate generally to a semiconductor memory device.

### BACKGROUND

A NAND type flash memory with a three-dimensional structure manufactured using a BiCS (Bit Cost Scalable Flash memory: BiCS) manufacturing technique is referred to in the art as BiCS memory.

### DESCRIPTION OF THE DRAWINGS

FIG. 1 is a block diagram of a semiconductor memory device according to a first embodiment.

FIG. 2 is a partial perspective view of a memory cell array according to the first embodiment.

FIG. 3 is a partial cross-sectional view of the memory cell array according to the first embodiment.

FIG. 4 is a cross-sectional view of a memory cell transistor according to the first embodiment.

FIG. 5 is a partial block diagram of the semiconductor memory device according to the first embodiment.

FIG. 6 is a partial top view of the memory cell array according to the first embodiment.

FIG. 7 is a conceptual diagram illustrating an address map according to the first embodiment.

FIG. 8 is a flowchart illustrating an erasing operation according to the first embodiment.

FIG. 9 is a timing chart illustrating the erasing operation according to the first embodiment.

FIG. 10 is a cross-sectional view of the semiconductor memory device when a part of the erasing operation is performed according to the first embodiment.

FIG. 11 is a conceptual diagram illustrating the erasing operation according to the first embodiment.

FIG. 12A is a flowchart illustrating the erasing operation according to the first embodiment.

FIG. 12B is a flowchart illustrating the erasing operation according to the first embodiment.

FIG. 13 is a cross-sectional view of a semiconductor memory device when a part of an erasing operation is performed according to a comparative example.

FIG. 14 is a cross-sectional view of the semiconductor memory device when a part of the erasing operation is performed according to the comparative example.

FIG. 15 is a flowchart illustrating an erasing operation according to a second embodiment.

FIG. 16 is a conceptual diagram illustrating the erasing operation according to the second embodiment.

### DETAILED DESCRIPTION

According to an embodiment, there is provided a semiconductor memory device which can secure an erasure state of a cell transistor with higher accuracy.

In general, according to one embodiment, a semiconductor memory device includes string units including a plurality of memory cells stacked above a semiconductor substrate; and

a control circuit configured to perform an erase operation per a block, the block including the string units, the control circuit being configured to perform an erase verify operation per string unit.

Hereinafter, an exemplary embodiment will be described with reference to the drawings. In addition, in the following description, constituent elements which have substantially same function and configuration are given the same reference numeral, and a repeated description will be made only as needed. It is noted that the drawings are schematic. Each exemplary embodiment described below illustrates a device or a method for embodying the technical spirit of this exemplary embodiment, and the technical spirit of the exemplary embodiment does not specify a material, a shape, a structure, a disposition, and the like of a constituent element to the following.

Each functional block may be realized in either of hardware and software of a computer, or through a combination thereof. For this reason, each functional block will be substantially described below from the viewpoint of the function thereof in order to clarify that each functional block can be either hardware or software. How to realize the described functions depends on various factors. A person skilled in the art may realize the described functions in various ways for each specific exemplary embodiment, and any such realization method is included in the scope of the exemplary embodiment. In addition, it is not essential that each functional block be differentiated as in the following. For example, some functions may be performed by a functional block different from the depicted functional block. Further, a depicted functional block may be divided into finer sub-functional blocks. Exemplary embodiments are not limited by any specific functional block.

### First Embodiment

1. Overall Configuration

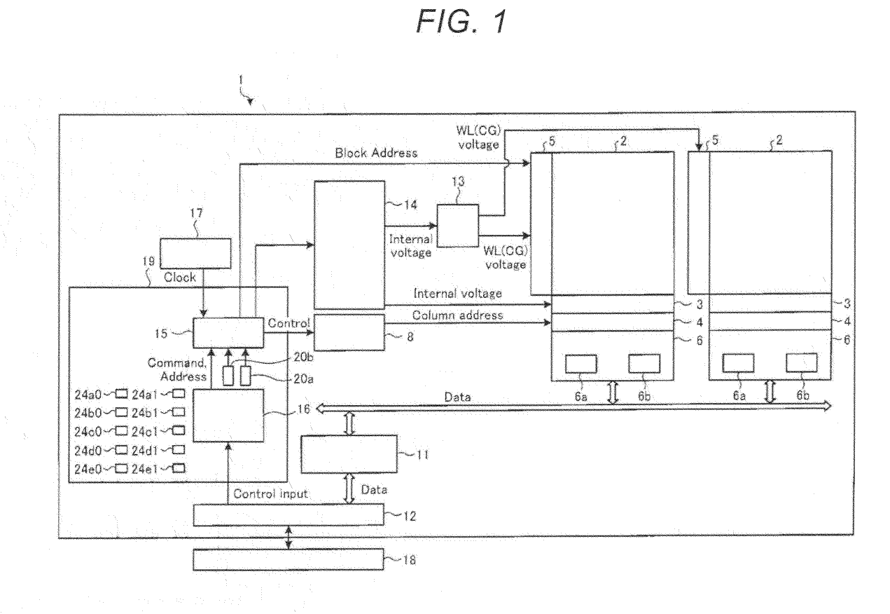

First, a configuration of a semiconductor memory device according to the first embodiment will be described with reference to FIGS. 1 to 6.

FIG. 1 is a block diagram of the semiconductor memory device according to the first embodiment. As shown in FIG. 1, a semiconductor memory device 1 includes memory cell arrays 2, sense amplifier units 3, page buffers 4, row decoders 5, column controllers 6, a data bus 7, a column decoder 8, a serial access controller 11, an I/O interface 12, a driver 13, a voltage generator 14, a sequencer 15, a command user interface 16, an oscillator 17, a control circuit 19, registers 20a and 20b, and registers 24a0 to 24e0 and 24a1 to 24e1. The semiconductor memory device 1 corresponds to, for example, a single semiconductor chip.

The semiconductor memory device 1 is controlled, for example, by an external memory controller 18. The memory controller 18 is electrically connected to the I/O interface 12. The semiconductor memory device 1 sends and receives data to and from the memory controller 18 via the I/O interface 12.

In addition, the control circuit 19 includes the sequencer 15, the command user interface 16, and the registers 20a and 20b.

Each functional block may be realized in either of hardware and software of a computer, or through a combination thereof. For this reason, each functional block will be substantially described below from the viewpoint of the function thereof in order to clarify that each functional block can be either hardware or software. How to realize the described functions depends on various factors. A person skilled in the art may realize the described functions in various ways for each specific exemplary embodiment, and any such realization method is included in the scope of the exemplary embodiment. In addition, it is not essential that each functional block be differentiated as in the following. For example, some functions may be performed by a functional block different from the depicted functional block. Further, a depicted functional block may be divided into finer sub-functional blocks. Exemplary embodiments are not limited by any specific functional block.

1.1 Overall Configuration of Memory Cell Array 2

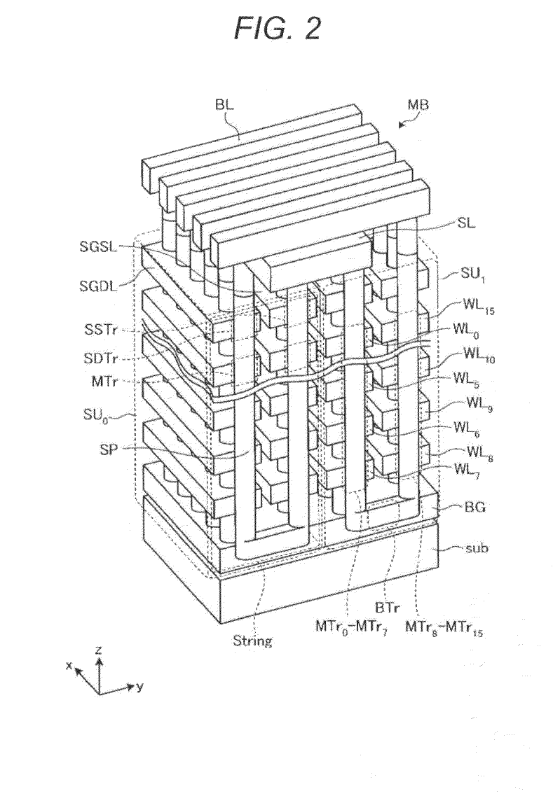

The semiconductor memory device 1 includes a plurality of memory cell arrays 2. FIG. 1 exemplifies two memory cell arrays 2, and the semiconductor memory device 1 may include three or more memory cell arrays 2. The memory cell array 2 is referred to as a plane in some cases. Two planes are respectively referred to as a plane 0 and a plane 1 in FIG. 1. Each of the memory cell arrays 2 includes a plurality of memory blocks (hereinafter, simply referred to as a block in some cases). Each block includes a plurality of string units. Each string unit includes a plurality of strings. Details thereof will be described later with reference to FIG. 2 and the like.

The string includes a plurality of cell transistors which are connected in series, two selection gate transistors of both ends thereof, and a back gate transistor. The back gate transistor may not be necessary in this embodiment.

The plurality of strings are connected to a single bit line. Some cell transistors share a word line. Among cell transistors sharing the word line, a page is composed of cell transistors included in a common string unit. Data is read and written per a page. On the other hand, data is erased per a block. The block is composed of a plurality of string units.

The memory cell array 2 has a three-dimensional structure. The present embodiment will be described using an example in which data is erased per a block but is not limited thereto, and, for example, data may be erased per string unit or per half of the string unit.

1.2 Detailed Description of Memory Cell Array 2

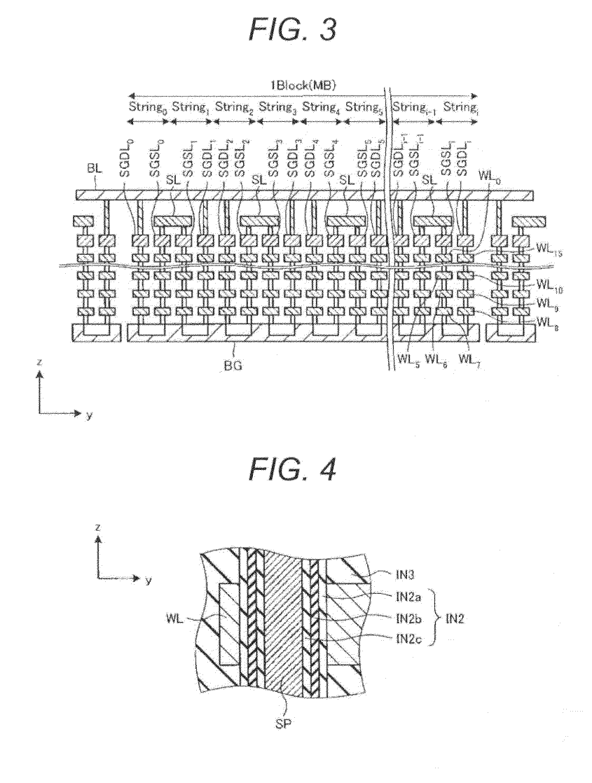

A configuration of the memory cell array 2 will be described in detail, for example, with reference to FIGS. 2 and 3. FIG. 2 is a partial perspective view of the memory cell array according to the first embodiment. FIG. 3 is a partial cross-sectional view of the memory cell array according to the first embodiment. In FIG. 2, a description will be made of an example of a perspective view of a block including two string units. FIG. 3 is a cross-sectional view of FIG. 2.

As shown in FIGS. 2 and 3, a back gate BG made of a conductive material is formed above a substrate sub. The back gate BG spreads in a x direction and a y direction. In addition, a plurality of string units SU are formed above the substrate sub. A plurality of strings “String” are formed in the string unit SU. Specifically, the string unit SU is formed by a plurality of strings “String” which are arranged in a direction (the x direction in FIG. 2) perpendicular to a bit line BL. A single block includes i string units. Here, i is a natural number. A string unit including a string “String₀” is referred to as a string unit SU₀. Similarly, a string unit including a string “String_{Y}” is referred to as a string unit SU_{Y} (where Y=1 to i−1). For convenience of illustration, in FIG. 2, only the string unit SU₀ and the string unit SU₁ are shown. If it is not necessary to differentiate reference signs (for example, strings String₀ to Stringᵢ₋₁) with numbers added to the ends from each other, a reference sign with no number added to the end is used, and this reference sign is assumed to indicate reference signs with all numbers added to the ends.

In FIG. 2, a single string “String” includes n memory cell transistors MTr. Here, n is a natural number. FIGS. 2 and 3 show an example in which a single string includes sixteen cell transistors MTr₀ to MTr₁₅. The cell transistors MTr₇ and MTr₈ are connected to each other via a back gate transistor BTr. First ends of a source side selection gate transistor SSTr and a drain side selection gate transistor SDTr are respectively electrically connected to the cell transistors MTr₀ and MTr₁₅. A source line SL and the bit line BL extend above the transistors SSTr and SDTr. Second ends of the transistor SSTr and the transistor SDTr are respectively electrically connected to the source line SL and the bit line BL.

The cell transistors MTr₀ to MTr₁₅ include a semiconductor pillar SP and an insulating film IN2 (shown in FIG. 4) on a surface of the semiconductor pillar SP. The semiconductor pillar SP is made of, for example, silicon. Two semiconductor pillars SP forming a single string “String” are connected to each other via a pipe layer which is made of a conductive material in the back gate BG. The pipe layer forms the back gate transistor BTr. The insulating film IN2 includes, as shown in FIG. 4, a block insulating film IN2c on the semiconductor pillar SP, an electric charge trap layer IN2b on the insulating layer IN2c, and a tunnel insulating film IN2a on the electric charge trap layer IN2b. The electric charge trap layer IN2b is made of an insulating material.

As shown in FIGS. 2 and 3, the cell transistors MTr₀ to MTr₁₅ are further connected to word lines (control gates) WL₀ to WL₁₅ which extend along the x direction. The word lines WL₀ to WL₁₅ are selectively connected to corresponding CG lines CG (CG lines CG₀ to CG₁₅) by the row decoder 5. The CG line CG is not shown in FIGS. 2 and 3. The cell transistor MTr stores in a nonvolatile manner data for example.

Gate electrodes (gates) of the respective cell transistors MTr₀ of a plurality of strings “String_{Y}” arranged along the x direction of each block MB are connected in common to the word line WL₀. Similarly, gates of the respective cell transistors MTr_{X} of a plurality of strings “String_{X}” arranged along the x direction of each block MB are connected in common to the word line WL_{X}. Here, X is 0 or a natural number which is equal to or less than n. In addition, the gates of the respective cell transistors MTr_{X} of a plurality of strings “String” arranged along a y direction of each block MB are connected in common to the word line WL_{X}. In other words, the word line WL₀ is shared by all the strings “String” of a single block MB. The word lines WL₁ to WL₁₅ are also shared in the same manner.

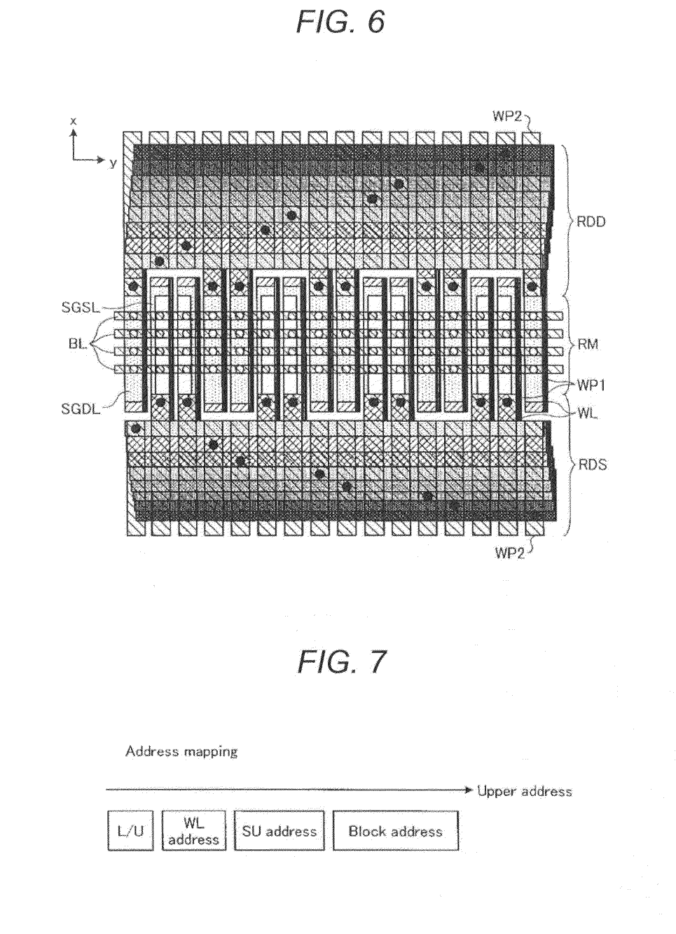

A plurality of strings “String” arranged along the y direction of each block MB are connected in common to the bit line BL. All of the cell transistors MTr₀ in the block MB are connected in common to the word line WL₀. Similarly, all of the cell transistors MTr_{Z} in the block MB are connected in common to the word line WL_{Z}. Here, Z is 0 or a natural number which is equal to or less than i. Each word line WL is formed in a comb-lobe shape as shown in FIG. 6 for example.

The word line WL includes a first part WP1 in a cell region RM, and a second part WP2 in extraction regions RDD and RDS. The extraction region RDD and the extraction region RDS are disposed so as to be opposite to each other. In addition, the cell region RM is disposed between the extraction region RDD and the extraction region RDS.

In the respective word lines WL, a comb-teeth shape is formed in which a plurality of first parts extend in the x direction from the second part.

In addition, the block MB has a feature in which the same voltage is applied to word lines of all the strings when data is erased, and thus the block MB is the unit of an erase operation. The gates of the back gate transistors BTr are connected in common to the back gate line BG.

Among a plurality of cell transistors MTr sharing the word line, the page may be composed of a memory cell transistor Mtr in a common string unit SU. One page has, for example, the size of 8 Kbyte. In addition, for example, if 2-bit data is held in each cell transistor MTr, among a plurality of cell transistors MTr sharing the word line WL, data of the memory cell transistors Mtr in a common string unit SU is composed of two pages.

The selection gate transistors SSTr and SDTr include the semiconductor pillar SP and a gate insulating film (not shown) on the surface of the semiconductor pillar SP, and respectively further include gates (selection gate lines) SGSL and SGDL. Gates of the respective source side selection gate transistors SSTr of a plurality of strings String₀ arranged along the x direction in each block MB are connected in common to the source side selection gate line SGSL₀. Similarly, gates of the respective transistors SSTr of a plurality of strings String_{Y} arranged along the x direction in each block MB are connected in common to the selection gate line SGSL_{Y}. The selection gate line SGSL extends along the x direction. The selection gate line SGSL is selectively connected to an SGS line SGS (not shown) by the row decoder 5. First ends of the respective transistors SSTr of two adjacent strings String are connected to the same source line SL. The source lines SL in a single block are connected to each other.

Gates of the respective drain side selection gate transistors SDTr of a plurality of strings String₀ arranged along the x direction in each block MB are connected in common to the drain side selection gate line SGDL₀. Similarly, gates of the respective transistors SDTr of a plurality of string String_{Y} arranged along the x direction in each block MB are connected in common to the selection gate line SGDL_{Y}. The selection gate line SGDL extends along the x direction. First ends of the respective transistors SDTr of all the strings String arranged along the y direction and in a single block are connected to the same bit line BL.

As described above, a plurality of strings StringY (connected to different bit lines BL) arranged along the x direction in each block MB share the selection gate lines SGSL and SGDL, and the word lines WL₀ to WL₁₅.

1.3 Overall Configurations of Sense Amplifier, Page Buffer, Row Decoder, and Column Controller

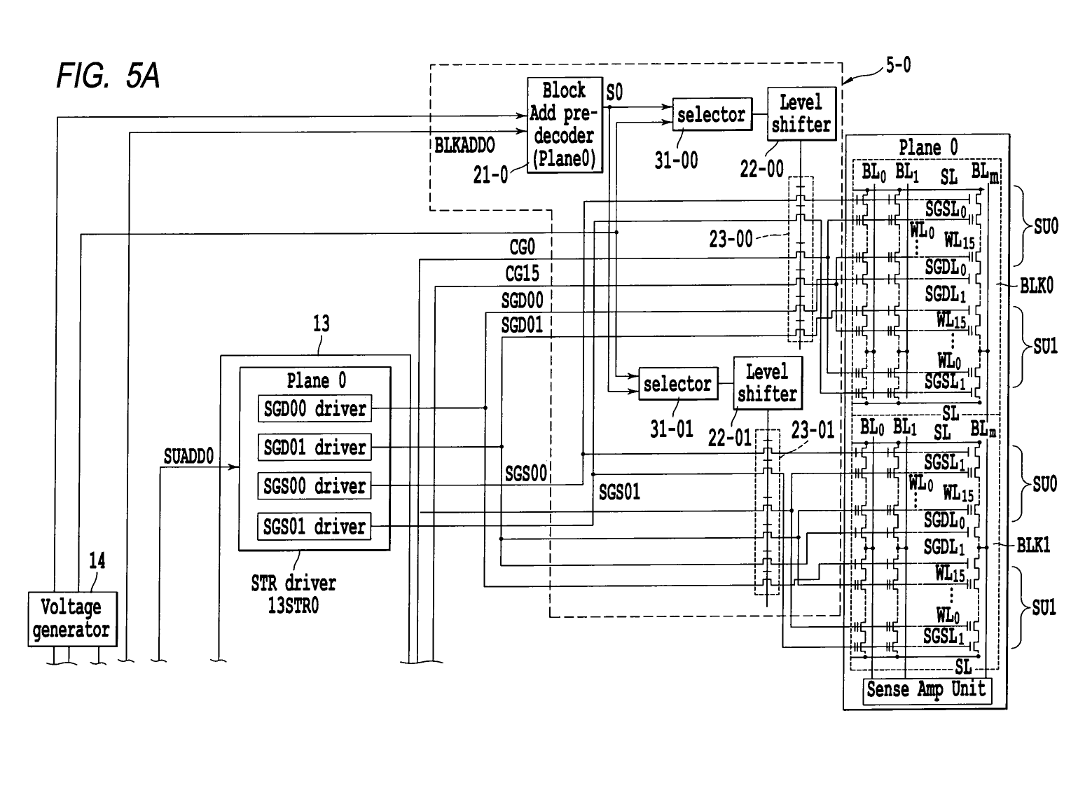

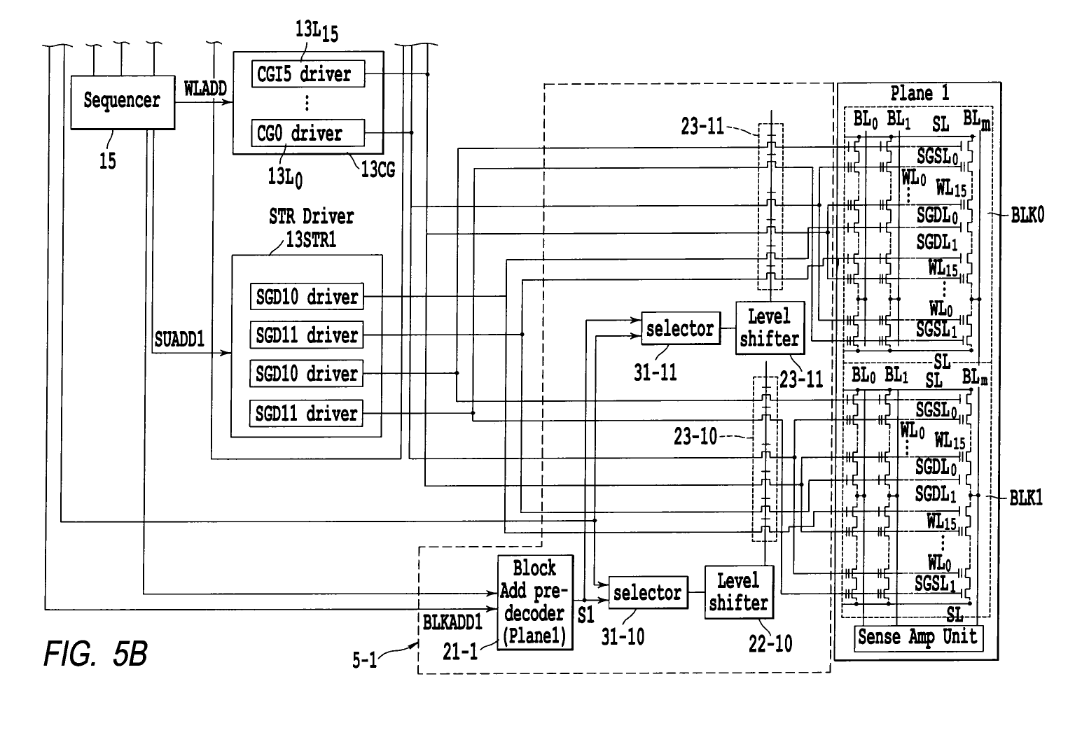

A set of the sense amplifier unit 3, the page buffer 4, the row decoder 5, and the column controller 6 is provided for each plane as you can see FIG. 1. For convenience of illustration, in the present embodiment, a case of a configuration of two planes is described as an example, and thus the row decoder 5 is indicated by a row decoder 5-0 and a row decoder 5-1 in FIG. 5. Each sense amplifier unit 3 includes a plurality of sense amplifier units which are respectively connected to a plurality of bit lines, and senses and amplifies a voltage of a corresponding bit line. Each page buffer 4 receives a column address, reads data from a selected page when reading is performed, temporarily holds the read data, and outputs the data to the data bus 7, based on the column address. Each page buffer 4 reads a result of an erase verify operation, intelligent soft-program verify operation (hereinafter, referred to as ITSP verify operation), or soft-program verify operation and temporarily holds the result when the erase verify operation, the ITSP verify operation, or the soft-program verify operation is performed per a string unit SU selected by the driver 13. Selection of the string unit SU will be described later in detail.

Here, a result of the erase verify operation, a result of the ITSP verify operation, and a result of the soft-program verify operation are all data of 8 Kbyte. In the result of the erase verify operation, “0” data of 1 bit is data indicating, for example, a string “String” in which the erase operation is completed for all memory cell transistors Mtr. “1” data of 1 bit is data indicating, for example, a string “String” including at least one memory cell transistor Mtr for which the erase operation is not completed. This is also the same for the ITSP verify operation or the soft-program verify operation.

In addition, each page buffer 4 receives data from an external device of the semiconductor memory device 1 via the data bus 7 based on a column address when data is written, and temporarily holds the received data. The column address is supplied by the column decoder 8.

The data bus 7 is electrically connected to the serial access controller 11. The serial access controller 11 is connected to the I/O interface 12. The I/O interface 12 includes a plurality of signal terminals, and takes an interface between the semiconductor memory device 1 and the external device. The serial access controller 11 performs control including conversion between a parallel signal on the data bus 7 and a serial signal passing through the I/O interface 12.

Each row decoder 5 receives a block address signal, and selects a block based on the received signal. Specifically, each row decoder 5 connects string drivers 13STR₀ and 13STR₁ and CG drivers 13C₀ to 13C₁₅ of the driver 13 to a string unit SU of a selected block. The driver 13 receives a voltage from the voltage generator 14 and generates voltages which are necessary for various operations (reading, writing, erasing, and the like) of the semiconductor memory device 1. Voltages output from the driver 13 are applied to the word lines and the gate electrodes of the selection gate transistors. The voltage generator 14 also supplies a voltage which is necessary for an operation of the sense amplifier unit 3 thereto.

Each column controller 6 has a function of calculating verify pass or verify failure of the erase verify operation, the ITSP verify operation, or the soft-program verify operation. Each column controller 6 includes two registers 6a and 6b. The register 6a holds data indicating the number of “1” data (the erasing verify operation is not completed) based on, for example, a result (data of 8 Kbyte) of the erase verify operation held in the page buffer 4. The register 6a holds data indicating the number of “0” data (the ITSP verify operation is completed) based on a result (data of 8 Kbyte) of the ITSP verify operation. In addition, the register 6a holds data indicating the number of “1” data (the soft-program verify operation is not completed) based on a result (data of 8 Kbyte) of the soft-program verify operation.

In addition, although, in the present embodiment, the data indicating the number of “1” data is held in the register 6a when the erase verify operation is performed, an embodiment is not limited thereto, and data indicating the number of “0” data may be held in the register 6a. Similarly, although data indicating the number of “0” data is held in the register 6a when the ITSP verify operation is performed, an embodiment is not limited thereto, and data indicating the number of “1” data may be held in the register 6a. Although data indicating the number of “1” data is held in the register 6a when the soft-program verify operation is performed, an embodiment is not limited thereto, and data indicating the number of “0” data may be held in the register 6a.

The control circuit 19 transmits, for example, a threshold value X1 held in the register 20a to the column controller 6. The register 6b holds the threshold value X1.

The column controller 6 determines whether the selected string unit SU passes the erase verify operation or fails in the erase verify operation on the basis of, for example, the data indicating the number of “1” data of the register 6a and the threshold value X1 of the register 6b. Details thereof will be described later.

The column controller 6 transmits an erase verify pass or an erase verify failure of the selected string unit SU to the control circuit 19.

The sequencer 15 of the control circuit 19 receives signals such as a command and an address from the command user interface 16, and is operated based on a clock from the oscillator 17. The sequencer 15 controls various constituent elements (functional blocks) of the semiconductor memory device 1 on the basis of the received signals. For example, the sequencer 15 controls the column decoder 8 and the voltage generator 14 on the basis of the received signals such as a command and an address. In addition, the sequencer 15 outputs the above-described block address and string unit address on the basis of the received signals such as a command and an address. The block address is different for each plane, and includes information for selecting different blocks or the same block for each plane. The string unit address is different for each plane, and includes information for selecting different strings or the same string for each plane. The command user interface 16 receives a control signal via the I/O interface 12. The command user interface 16 decodes the received control signal so as to acquire a command, an address, and the like.

The semiconductor memory device 1 may have a configuration in which data of 2 bits or more can be held in a single memory cell.

The control circuit 19 includes a plurality of registers 24a0 to 24e0 and 24a1 to 24e1. The register 24a0 is a register in which, for example, “1” is set, when a selected block of the plane 0 fails in the erase verify operation. The register 24b0 is a register in which, for example, “1” is set, when a selected block of the plane 0 fails in the ITSP verify operation. The register 24c0 is a register in which, for example, “1” is set, when a selected block of the plane 0 fails in the soft-program verify operation. The register 24d0 is a register in which, for example, “1” is set, when “1” is set in any one of the registers 24a0 to 24c0.

The register 24e0 is a register in which, for example, “1” is set, when a selected block of the plane 0 passes the soft-program verify operation.

The register 24a1 is a register in which, for example, “1” is set, when a selected block of the plane 1 fails in the erasing verify operation. The register 24b1 is a register in which, for example, “1” is set, when a selected block of the plane 1 fails in the ITSP verify operation. The register 24c1 is a register in which, for example, “1” is set, when a selected block of the plane 1 fails in the soft-program verify operation. The register 24d1 is a register in which, for example, “1” is set, when “1” is set in any one of the registers 24a1 to 24c1.

The register 24e1 is a register in which, for example, “1” is set, when a selected block of the plane 1 passes the soft-program verify operation.

1.4 Detailed Description of Row Decoder, Driver, and Sequencer

Next, specific configurations of the row decoder 5, the driver 13, and the sequencer 15 will be described with reference to FIG. 5. FIG. 5 is a partial block diagram of the semiconductor memory device according to the first embodiment. FIG. 5 particularly shows constituent elements regarding decoding in FIG. 1 and constituent elements related thereto.

For convenience of illustration, FIG. 5 shows that the semiconductor memory device includes the plane 0 and the plane 1. Each of the planes 0 and 1 includes two blocks BLK0 and BLK1, and each block BLK is shown to include two string units SU. The number of planes, the number of blocks BLK, and the number of string units SU are not limited to two, and a different number of planes, a different number of blocks, and a different number of string units may be used.

As shown in FIG. 5, the row decoder 5 according to the present embodiment includes the row decoder 5-0 for the plane 0, the row decoder 5-1 for the plane 1, and selection portions 31-00, 31-01, 31-10 and 31-11. The selection portions 31-00 and 31-01 are used for the plane 0, and the selection portions 31-10 and 31-11 are used for the plane 1. The row decoders 5-0 and 5-1 include the same configuration (constituent element and connection). In addition, the selection portions 31-00, 31-01, 31-10 and 31-11 have the same configuration. Hereinafter, constituent elements related to the plane 0 will be described. However, the following description is also applied to the plane 1. The semiconductor memory device of FIG. 5 also corresponds to, for example, a single semiconductor chip as described in FIG. 1.

The driver 13 includes the string driver 13STR₀ and 13STR₁, and the CG drivers 13C₀ to 13C₁₅. The string driver 13STR₀ has a function of selecting a string for the plane 0. The string driver 13STR₁ has a function of selecting a string for the plane 1.

The string driver 13STR₀ includes two SGD drivers 13SGD₀₀ and 13SGD₀₁ and two SGS drivers 13SGS₀₀ and 13SGS₀₁. In addition, the string driver 13STR₁ includes two SGD drivers 13SGD₁₀ and 13SGD₁₁ and two SGS drivers 13SGS₁₀ and 13SGS₁₁.

The two SGD drivers 13SGD₀₀ and 13SGD₀₁, the two SGD drivers 13SGD₁₀ and 13SGD₁₁, the two SGS drivers 13SGS₀₀ and 13SGS₀₁, the two SGS drivers 13SGS₁₀ and 13SGS₁₁, and the CG line drivers 13C₀ to 13C₁₅ respectively drive SG lines SGD₀₀ and SGD₀₁ connected to each block BLK of the plane 0, SG lines SGD₁₀ and SGD₁₁ connected to each block BLK of the plane 1, SG lines SGS₀₀ and SGS₀₁ connected to each block BLK of the plane 0, SG lines SGS₁₀ and SGS₁₁ connected to each block BLK of the plane 1, and CG lines CG₀ to CG₁₅, to voltages which are defined under the control of the sequencer 15. The driver 13 is common to the plane 0 and the plane 1. The driver 13 receives an address (hereinafter, also referred to as a string unit address signal SUADD) indicating the string unit SU from the sequencer 15, and selects the string unit. Specifically, the driver 13 receives a string unit address signal SUADD0 of the plane 0 and a string unit address signal SUADD1 of the plane 1, and controls the four SGD drivers 13SGD₀₀ to 13SGD₁₁ and the four SGS drivers 13SGS₀₀ to 13SGS₁₁.

The row decoder 5-0 includes a block address pre-decoder 21-0, two level shifters 22-00 and 22-01, and two transfer transistor groups 23-00 and 23-01.

The block address pre-decoder 21-0 is electrically connected to the selection portions 31-00 and 31-01. The selection portions 31-00 and 31-01 are respectively electrically connected to the level shifters 22-00 and 22-01. The level shifter 22-00 is electrically connected to gates of the respective transfer transistors of the transfer transistor group 23-00. The level shifter 22-01 is electrically connected to gates of the respective transfer transistors of the transfer transistor group 23-01.

The block address pre-decoder 21-0 receives a block address signal BLKADD0 from the sequencer 15, and outputs a signal S0 for selecting the block BLK to the selection portions 31-00 and 31-01. Either one of the transfer transistor groups 23-00 and 23-01 is selected by the selection portions 31-00 and 31-01. For example, when the block BLK0 is selected, a signal of a high level is applied to the gates of the transfer transistor group 23-00, and thus the respective transfer transistors of the transfer transistor group 23-00 are turned on. As a result, the word lines WL₀ to WL₁₅ of the block BLK0 are connected to the CG lines CG₀ to CG₁₅.

The CG lines CG₀ to CG₁₅ are electrically connected to the CG drivers 13C₀ to 13C₁₅ of the driver 13 via the transfer transistor groups 23-00 and 23-01.

In the plane 0, an SG line SGDL₀ of the string unit SU₀ of each block BLK is electrically connected to the SGD driver 13SGD₀₀ via each of the transfer transistor groups 23-00 and 23-01. In the plane 0, an SG line SGSL₀ of the string unit SU₀ of each block BLK is electrically connected to the SGS driver 13SGS₀₀ via each of the transfer transistor groups 23-00 and 23-01. In the plane 0, an SG line SGDL₁ of the string unit SU₁ of each block BLK is electrically connected to the SGD driver 13SGD₀₁ via each of the transfer transistor groups 23-00 and 23-01. In the plane 0, an SG line SGSL₁ of the string unit SU₁ of each block BLK is electrically connected to the SGS driver 13SGS₀₁ via each of the transfer transistor groups 23-00 and 23-01.

1.5 Control Circuit 19

The control circuit 19 is capable of controlling operations of the entire semiconductor memory device 1. The control circuit 19 includes the sequencer 15, the command user interface 16, the registers 20a and 20b, and the registers 24a0 to 24e0 and 24a1 to 24e1.

The sequencer 15 executes some operations in a write operation, a read operation, and a erase operation on the basis of a command and an address supplied from the command user interface 16.

The sequencer 15 controls an operation of each block in the semiconductor memory device 1 in order to execute some operations. As shown in FIG. 5, the sequencer 15 supplies the block address signal BLKADD0 to the block address pre-decoder 21-0 of the plane 0, supplies a block address signal BLKADD1 to a block address pre-decoder 21-1 of the plane 1, and supplies the string unit address signals SUADD0 and SUADD1 to the driver 13.

The register 20a sets threshold values X1 to X3 described later to, for example, the time of power-on. The threshold value X1 is maintained as a value correlated with the erase verify operation. The threshold value X2 is maintained as a value correlated with the ITSP verify operation. The threshold value X3 is maintained as a value correlated with the soft-program verify operation.

The register 20b is a register which is capable of holding erase verify pass and erase verify failure of each string unit SU, ITSP verify pass and ITSP verify failure thereof, and soft-program verify pass and soft-program verify failure thereof for each plane.

When a write operation, a read operation, and the like are performed, a command, data, and an address are supplied from an external device to the semiconductor memory device 1 via the I/O interface 12. An example of the address of the present embodiment will be described with reference to FIG. 7.

FIG. 7 is a conceptual diagram illustrating an example of address mapping according to the present embodiment.

As shown in FIG. 7, the sequencer 15 sequentially receives addresses of lower page/upper page (in FIG. 7, L/U), a word line address (in FIG. 7, WL address), a string unit address (in FIG. 7, SU Address), and a block address (in FIG. 7, Block Address).

As shown in FIG. 5, the sequencer 15 supplies the block address signals BLKADD0 and BLKADD1 to the block address pre-decoders 21-0 and 21-1, respectively. In addition, the sequencer 15 supplies the string unit address signals SUADD0 and SUADD1, and a word line address signal WLA to the driver 13. Here, the signal SUADD0 is a signal supplied to the plane 0. The signal SUADD1 is a signal supplied to the plane 1. Similarly, the signal BLKADD0 is a signal supplied to the plane 0. The signal BLKADD1 is a signal supplied to the plane 1. Details thereof will be described later.

A word line address signal WLADD is assumed to use a word line address signal common to a plurality of planes. In addition, the word line address signal WLADD may be set to be common to a plurality of planes, and thus the same word line WL may be selected among a plurality of planes. Further, the word line address signal WLADD may be changed for each plane, and thus a different word line WL may be selected for each plane.

The block address pre-decoder 21-0 receives the block address signal BLKADD0 from the sequencer 15. The block address signal BLKADD0 includes data for selecting a desired block in the memory cell array 2 of the plane 0. The block address pre-decoder 21-0 decodes the block address signal BLKADD0, and outputs the signal S0 to the selection portions 31-00 and 31-01 so as to select a desired block BLK. Here, the signal S0 is a signal for selecting a certain block BLK of the plane 0.

For example, if the block BLK0 is selected, the transfer transistor group 23-00 is turned on via the selection portions 31-00 and 31-01, and the level shifters 22-00 and 22-01.

The level shifter 22-00 receives a necessary voltage VRDEC from the selection portion 31-00. The selection portion 31-00 receives a necessary voltage from the voltage generator 14 so as to generate the voltage VRDEC. The selection portion 31-00 is realized as a part of the function of the voltage generator 14 and is in the voltage generator 14.

The sequencer 15 supplies the string unit address signal SUADD0 to the string driver 13STR₀ and supplies the word line address signal WLADD to the CG drivers 13C₀ to 13C₁₅, so as to select a desired string unit SU and a desired word line WL. The string unit address signal SUADD0 includes data for selecting a desired string unit SU in the memory cell array 2 of the plane 0.

For example, if the string unit SU₀ of the block BLK0 is selected, a signal of a high level is transmitted to the SG lines SGSL₀ and SGDL₀, and a signal of a low level is transmitted to the SG lines SGSL₁ and SGDL₁ corresponding to another string unit SU₁.

As a result, the selection gate transistors of the string unit SU₀ are turned on, and the selection gate transistors of the string unit SU₁ are turned off.

The above description is also applied to the plane 1 in the same manner except for the following matter. That is, the block address pre-decoder 21-1 for the plane 1 receives the block address signal BLKADD1. The block address signal BLKADD1 includes data for selecting a desired block in the memory cell array 2 of the plane 1. The block address pre-decoder 21-1 decodes the block address signal BLKADD1, and outputs a signal S1 to the selection portions 31-10 and 31-11 so as to select a desired block BLK. Here, the signal S1 is a signal for selecting a certain block BLK of the plane 1.

The sequencer 15 supplies the string unit address signal SUADD1 to the string driver 13STR₁ and supplies the word line address signal WLADD to the CG drivers 13C₀ to 13C₁₅, so as to select a desired string unit SU and a desired word line WL. The string unit address signal SUADD1 includes data for selecting a desired string unit SU in the memory cell array 2 of the plane 1.

For example, if the string unit SU₀ of the block BLK0 is selected, a signal of a high level is transmitted to the SG lines SGSL₀ and SGDL₀, and a signal of a low level is transmitted to the SG lines SGSL₁ and SGDL₁ corresponding to another string unit SU₁.

As a result, the selection gate transistors of the string unit SD₀ are turned on, and the selection gate transistors of the string unit SU₁ are turned off.

The block address signal BLKADD1 is different from the block address signal BLKADD0. The string unit address signal SUADD0 is different from the string unit address signal SUADD1. Therefore, the string unit SU selected in the plane 0 and the string unit SU selected in the plane 1 are independent from each other. In addition, although, in the present embodiment, the block address signals BLKADD0 and BLKADD1, and the string unit address signals SUADD0 and SUADD1 are different from each other, respectively, an embodiment is not limited thereto, and, for example, the string unit address signal SUADD0 may be the same as the string unit address signal SUADD1.

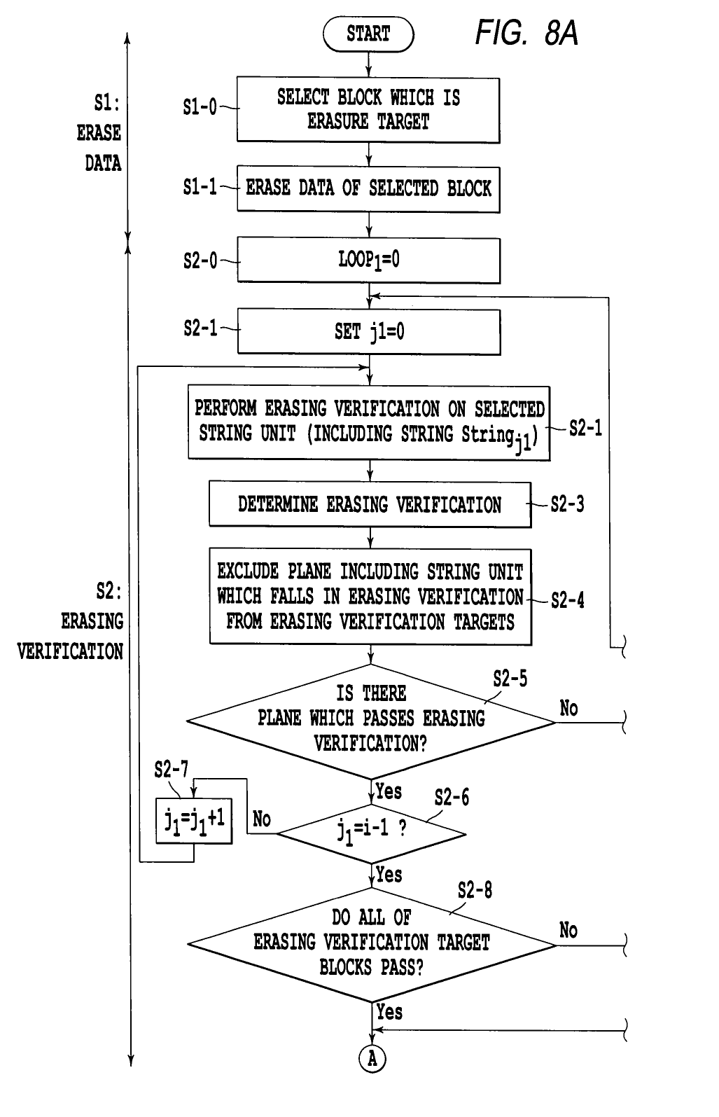

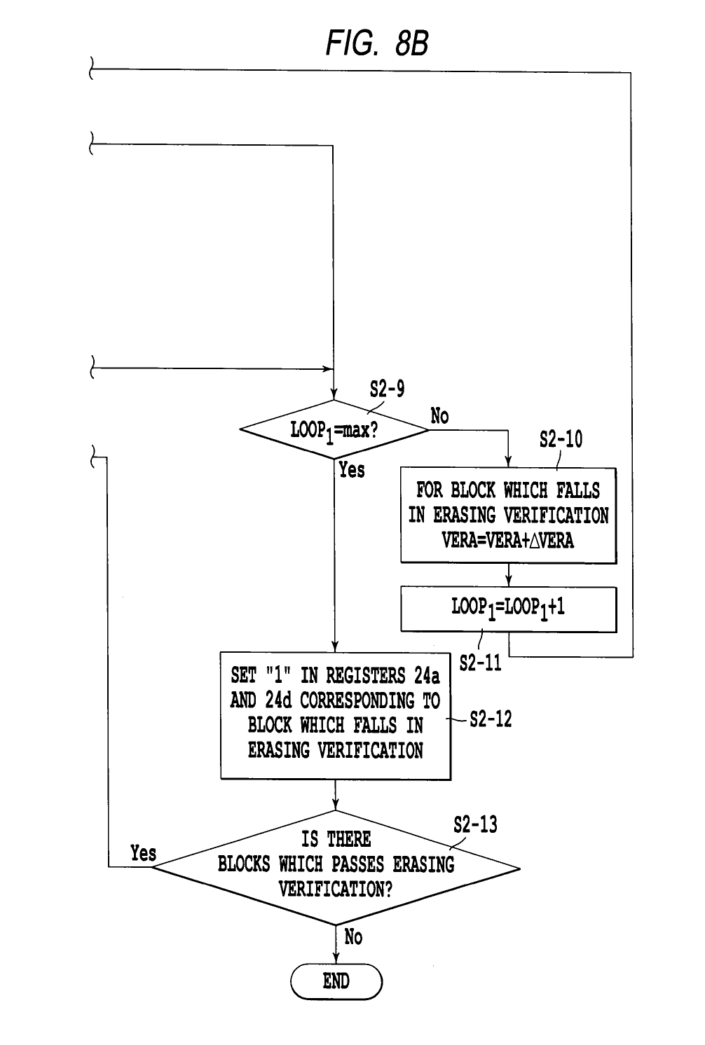

Next, the erase operation of the semiconductor memory device according to the present embodiment will be described with reference to FIG. 8. FIG. 8 shows an example of an operation of the sequencer 15.

2. Outline of Erasing Operation

The erase operation according to the present embodiment includes the erase verify operation for each string unit of a selected block after data is erased for the selected block. A plurality of verify operations in the erase operation are performed in the unit of the string unit, and thereby it is possible to provide a semiconductor memory device which can secure an erase state of a cell transistor with higher accuracy.

The erase operation according to the present embodiment includes soft-programming for a selected block, the ITSP verify operation for each string unit, and the soft-program verify operation for each string unit, after the erasing verify operation is performed.

In addition, although, in the present embodiment, the erase verify operation, the ITSP verify operation, and the soft-program verify operation are performed for each string unit, an embodiment is not limited thereto, and the erase verify operation, the ITSP verify operation, and the soft-program verify operation may be collectively performed for a selected block.

FIG. 8 is a flowchart illustrating an erasing operation according to the first embodiment. A description will be made assuming that each of the plane 0 and the plane 1 includes two blocks, and each block includes i string units SU. In addition, in the present embodiment, each plane includes two blocks but is not limited thereto, and may include k (where k is a natural number) blocks.

2.1 Step S1

First, in step S1-0, a block which is an erasure target is selected. Specifically, the sequencer 15 sets, as blocks which are erasure targets, a block which is selected by the block address signal BLKADD0 and in which “1” is not set in any of the registers 24a0 to 24e0 from the plane 0, and a block which is selected by the block address signal BLKADD1 and in which “1” is not set in any of the registers 24a1 to 24e1 from the plane 1.

In addition, although, in the present embodiment, a case where two planes are erased is described as an example, an embodiment is not limited thereto, and, for example, only one plane may be erased. In this case, the sequencer 15 sets “1” in the register 24e1 corresponding to the non-selected plane.

In step S1-1, data of the memory cell of the block selected in step S1-0 is erased.

Specifically, the sequencer 15 receives a command and addresses (a block address, a string unit address, and the like) and starts to execute step S1. The sequencer 15 supplies the block address signals BLKADD0 and BLKADD1 to the row decoder 5, and supplies the string unit address signals SUADD0 and SUADD1 and the word line address signal WLADD to the driver 13. More specifically, the string unit address signal SUADD0 is supplied to the string driver 13STR₀, the string unit address signal SUADD1 is supplied to the string driver 13STR₁, and the word line address signal WLADD is supplied to the CG drivers 13C₀ to 13C₁₅.

The block address signal BLKADD0 is a signal for selecting any one of the blocks BLK of the plane 0. The block address signal BLKADD1 is a signal for selecting any one of the blocks BLK of the plane 1. The string unit address signal SUADD0 is a signal for selecting any one of the string units SU or all of the string units SU in the plane 0. The string unit address signal SUADD1 is a signal for selecting any one of the string units SU or all of the string units SU in the plane 1.

For convenience of description, a description will be made of an example in which the block BLK0 is selected by the block address signal BLKADD0 in the plane 0 and the block BLK0 is selected by the block address signal BLKADD1 in the plane 1, in the erase operation according to the present embodiment.

The block address pre-decoder 21-0 receives the block address signal BLKADD0, and outputs the signal S0 for selecting the block BLK0 of the plane 0 to the selection portions 31-00 and 31-01. Similarly, the block address pre-decoder 21-1 receives the block address signal BLKADD1, and outputs the signal 51 for selecting the block BLK0 of the plane 1 to the selection portions 31-10 and 31-11. As a result, the transfer transistor group 23-00 corresponding to the block BLK0 of the plane 0 and the transfer transistor group 23-11 corresponding to the block BLK0 of the plane 1 are turned on.

In step S1, the voltage generator 14 generates a voltage VERA which is applied to the bit line BL or the source line SL. When a voltage which is about 8 V lower than the voltage VERA is applied to the respective selection gate lines SGDL and SGSL of the blocks BLK0 of the plane 0 and the plane 1 which are erasure targets, electron-hole pairs are generated by a phenomenon called GIDL in the semiconductor pillar SP around the gate edge on the bit line BL side of the drain side selection gate transistor SDTr or in the semiconductor pillar SP around the gate edge on the source line SL side of the source side selection gate transistor SSTr. The semiconductor pillar SP in the string “String” is charged to the voltage VERA by the electron-hole pairs. At this time, a voltage of 0 V is supplied to the control gate CG of the cell transistor MTr so as to inject holes into a charge storage layer, and thus a threshold voltage of the memory cell is reduced.

2.2 Step S2

2.2.1 Flow of step S2

Next, in step S2, the erase verify operation is performed for each string unit SU selected in each plane. In the erase verify operation, it is verified that the number of strings “String” including at least one cell transistor MTr of which a threshold voltage is higher than a desired voltage Vev0 is equal to or smaller than the threshold value X1 in the selected string unit SU. That is, the erase verify operation has a function of verifying that a threshold voltage of each cell transistor MTr is, for example, a negative voltage after data is erased in step S1.

Here, the threshold value X1 is an empirical value. For example, the threshold value X1 may be set to a value defined based on a correction performance of ECC (Error Check and Correct). For example, the threshold value X1 may be the number of errors which can be corrected by using ECC.

In the present embodiment, in order to perform the erase verify operation without generating a negative voltage applied to the word line WL, not a negative voltage but a voltage Vev1 (for example, 0 V) is applied as a voltage of the word line WL in a state in which a voltage of the source line SL increases to Vsl (for example, 1 V to 2 V), and thereby it is artificially verified whether the number of strings “String” including at least one cell transistor MTr of which a threshold voltage is higher than the desired voltage Vev0 is equal to or less than the threshold value X1.

The sequencer 15 sets LOOP1=0 in step S2-0. In addition, LOOP1 may have a value different from LOOP2 and LOOP3 described later. Further, the sequencer 15 sets j1=0 in step S2-1. The reference sign j1 specifies a string unit.

In step S2-2, the sequencer 15 supplies the string unit address signals SUADD0 and SUADD1 to the driver 13. String units SUⱼ₁ including strings “Stringⱼ₁” in the plane 0 and the plane 1 are selected by the string unit address signals SUADD0 and SUADD1.

The driver 13 receives the string unit address signals SUADD0 and SUADD1 at j1=0 which is the initial setting in step S2-1. The driver 13 selects the string unit SU₀ on the basis of the string unit address signals SUADD0 and SUADD1.

Therefore, the string unit SU₀ of the block BLK0 of each of the plane 0 and the plane 1 is selected.

In the plane 0 and the plane 1, the driver 13 applies the desired voltage Vev1 for the erase verify operation to the CG lines CG₀ to CG₁₅ in a state in which the source line SL is set to the first voltage Vsl and the bit lines BL0 to BLm are precharged. desired voltages are transmitted to the word line WL of the selected block BLK0 through the transfer transistor group 23-00 of the plane 0 and the transfer transistor group 23-10 of the plane 1.

The bit lines BL0 to BLm are respectively electrically connected to the corresponding strings “String” of the selected string unit SU₀ and a cell current is detected, and thereby the erase verify operation is performed on the string units SU₀ of the selected blocks BLK0 of the plane 0 and the plane 1. That is, if a threshold voltage of the cell transistor MTr of the selected string unit SU is lower than the desired voltage Vev0, a voltage of the bit line BL or a voltage of a sen node (not shown) is discharged. When a type of the sense amplifier unit is ABL type, a read data is determined based on a voltage of the sen node in the sense amplifier unit. A configuration of the sense amplifier unit is disclosed in U.S. patent application Ser. No. 12/563,296, filed on Sep. 21, 2009, entitled “Nonvolatile semiconductor memory”. The entire contents of the above-identified Patent Applications are incorporated by reference in the present application. On the other hand, if the selected string unit SU includes at least one cell transistor MTr of which a threshold voltage is higher than the desired voltage Vev0, a voltage of the bit line BL or a voltage of a sen node is maintained.

A result (for example, 8 Kbyte) of the erase verify operation of the selected string unit SU₀ of the selected block BLK0 is held in the sense amplifier (S0 in FIG. 5) 3 of each of the plane 0 and the plane 1.

In step S2-3, the column controller 6 counts the number of “1” data (the erase verify operation failure) from the result of the erase verify operation in step S2-2, and holds data indicating the number of “1” data in the register 6a. In addition, the column controller 6 reads a threshold value held in the register 20a of the sequencer 15. That is, the sequencer 15 transmits the threshold value X1 corresponding to the erase verify operation to the register 6b of the column controller 6, and the column controller 6 holds the threshold value X1 in the register 6b.

The column controller 6 determines whether or not the selected string unit SUⱼ₁ passes the erase verify operation or fails in the erase verify operation on the basis of the data indicating the number of “1” data and the threshold value X1.

The column controller 6 determines whether or not the number of “1” data in the string unit SUⱼ₁ of the plane 0 is equal to or less than the threshold value X1. Similarly, the column controller 6 determines whether or not the number of “1” data in the string unit SU_{E}) of the plane 1 is equal to or less than the threshold value X1.

If the number of “1” data is equal to or less than the threshold value X1, the column controller 6 determines that the string unit SU₀ passes the erase verify operation, and if the number of “1” data is more than the threshold value X1, the column controller 6 determines that the string unit SU₀ fails in the erase verify operation.

In addition, the column controller 6 transmits the erase verify pass or the erase verify failure of a string unit selected for each plane to the sequencer 15 via the data bus 7.

The erase verify pass or the erase verify failure of a string unit selected for each plane is held in the register 20b of the control circuit 19.

In step S2-4, the sequencer 15 sets a plane including a block BLK in which the selected string unit SUⱼ₁ fails in the erase verify operation to be excluded from targets of the erase verify operation until Re-erase operation is performed in step S2-10.

In step S2-5, the sequencer 15 determines whether or not there is a plane in which it is determined that the selected string unit Stiⱼ₁ passes the erase verify operation. If the selected string unit SUⱼ₁ fails in the erase verify operation in both of the plane 0 and the plane 1 (No in step S2-5), the sequencer 15 proceeds to step S2-9.

On the other hand, if the selected string unit SUⱼ₁ passes the erase verify operation in at least one of the plane 0 and the plane 1 (Yes in step S2-5), the sequencer 15 proceeds to step S2-6. The sequencer 15 determines whether or not j1 is i−1. If j1 is not i−1 (No in step S2-6), the sequencer 15 increments j1 (step S2-7), and returns to step S2-2.

If j1 is i−1 (Yes in step S2-6), the sequencer 15 determines whether or not all the string units SU of the block BLK selected in step S1-1 pass the erase verify operation in the plane 0 and the plane 1 (step S2-8). If all the string units SU pass the erase verify operation (Yes in step S2-8), the flow proceeds to the subsequent step so as to perform soft-programming. On the other hand, if any one of the string units SU of the selected block BLK fails in the erase verify operation (No in step S2-8), the sequencer 15 determines whether or not LOOP1 (the number of loops) exceeds a threshold value (the maximum loop number) (step S2-9).

If LOOP1 (the number of loops) does not exceed the threshold value (the maximum loop number) (No in step S2-9), the sequencer 15 selects again a block BLK including a string unit SU which fails in the erase verify operation so as to erase data of the block BLK again (step S2-10). Here, an erasing voltage (for example, 20 V) used for the erase operation is stepped up.

In step S2-11, the sequencer 15 increments LOOP1 and returns to step S2-1 again.

If LOOP1 (the number of loops) reaches the threshold value (maximum loop number) (Yes in step S2-9), the sequencer 15 sets “1” in the corresponding registers 24a0 and 24d0 when the selected block of the plane 0 fails in the erase verify operation. Similarly, the sequencer 15 sets “1” in the corresponding registers 24a1 and 24d1 when the selected block of the plane 1 fails in the erase verify operation (step S2-12).

In step S2-13, the sequencer 15 determines whether or not statuses of the plane 0 and the plane 1 are fixed. That is, the sequencer 15 determines whether or not “1” is set in the register 24d0 or the register 24e0 corresponding to the plane 0, and “1” is set in the register 24d1 or the register 24e1 corresponding to the plane 1.

If “1” is set in either of the register 24d0 or the register 24e0 and “1” is set in either of the register 24d1 or the register 24e1, the sequencer 15 finishes the erase operation (end).

A detailed description thereof will be made using a specific example.

In relation to steps S2-3 to 2-7, an example is shown in which the string unit SU₀ of the plane 0 passes the erase verify operation, and the string unit SU₀ of the plane 1 fails in the erase verify operation.

In this case, in step S2-3, the column controller 6 determines that the string unit SU₀ of the plane 0 passes the erase verify operation, and determines that the string unit SU₀ of the plane 1 fails in the erase verify operation (step S2-3). Since the selected string unit SU₀ of the plane 1 fails in the erase verify operation, the sequencer 15 sets the plane 1 so as not to be selected in next erase verify operation (step S2-4).

Since the string unit SU₀ of the plane 0 passes the erase verify operation (Yes in step S2-5), the sequencer 15 determines that j1 is not i−1 since j1 is 0 (No in step S2-6), and proceeds to step S2-7.

In addition, in step S2-7, the sequencer 15 increments j1 (j1=1), and proceeds to step S2-2.

2.2.2 Timing Chart of Step S2

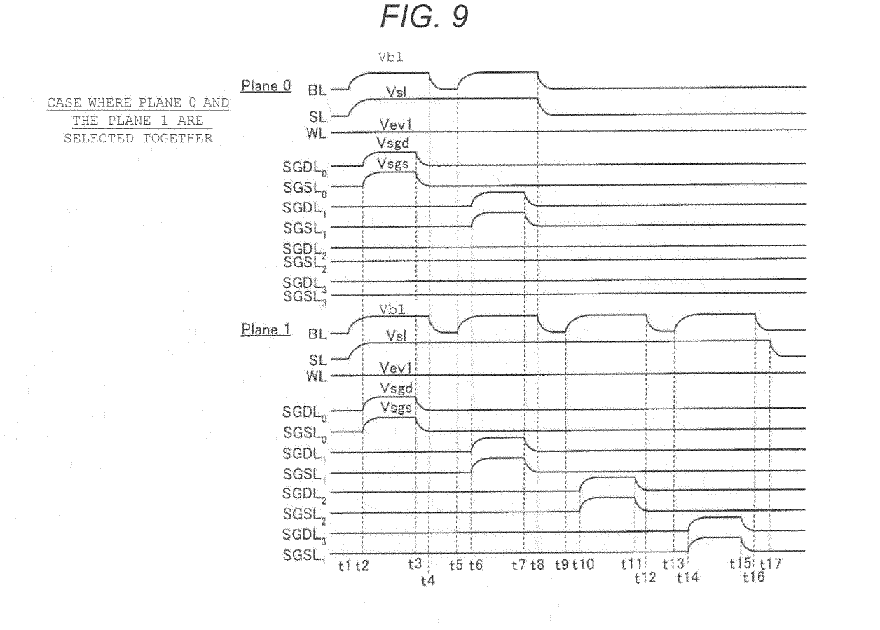

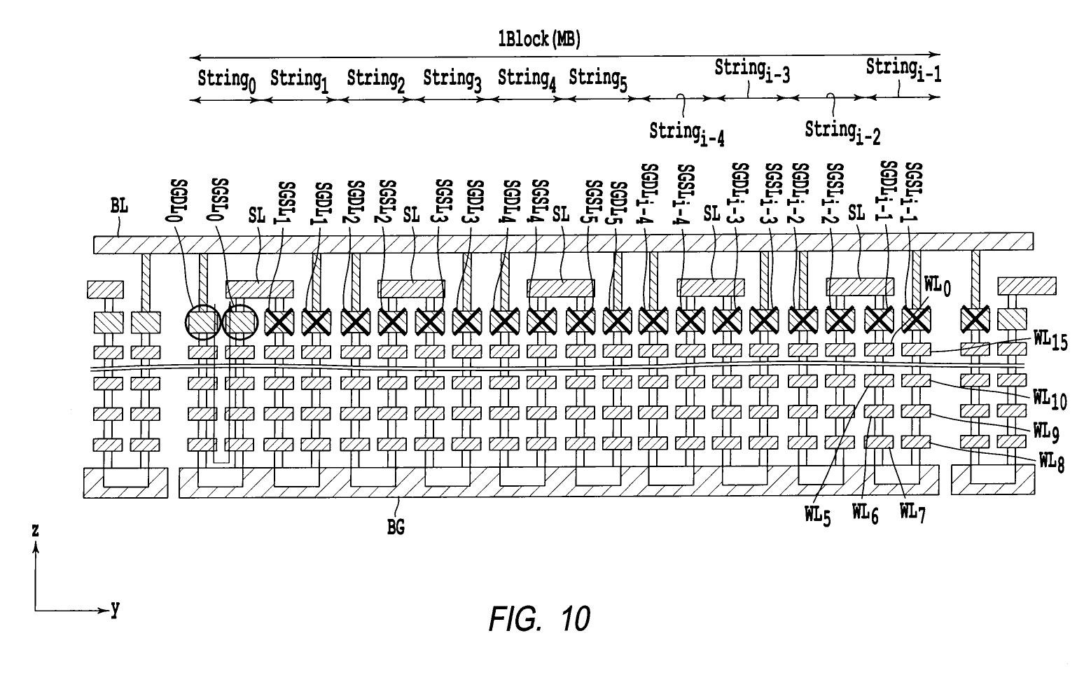

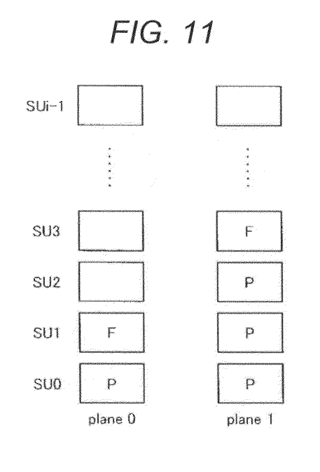

Next, the erase verify operation in step S2 will be described with reference to a timing chart of FIG. 9, and FIGS. 10 and 11. For convenience of description, a description will be made of an example in which the plane 0 and the plane 1 are selected together, and, in each plane, a string unit is selected and the erase verify operation is performed in ascending order of the string unit SU₀, the string unit SU₁, and a string unit SU₂, . . . .

In addition, it is assumed that the string unit SU₀ of the plane 0 passes the erase verify operation, and the string unit SU₁ fails in the erase verify operation. On the other hand, it is assumed that the string units SU₀ to SU₂ of the plane 1 pass the erase verify operation, and the string unit SU₃ fails in the erase verify operation. Hereinafter, the operation in step S2 based thereon will be described.

2.2.2.1 Time t1

First, at a time t1, the bit lines BL0 to BLm are precharged to a voltage Vbl. A voltage of the source line SL increases to the voltage Vsl. The word lines WL of the block BLK0 of the plane 0 and the block BLK0 of the plane 1 are maintained at the voltage Vev1.

At a time t2, the string unit SU₀ of each of the block BLK0 of the plane 0 and the block BLK0 of the plane 1 is selected. That is, a voltage Vsgd is applied to all the drain side selection gate transistors SDTr in the string unit SU₀ of each of the blocks BLK0 of the plane 0 and the plane 1, thereby turning on all the drain side selection gate transistors SDTr. Similarly, a voltage Vsgs is applied to all the source side selection gate transistors SSTr in the string unit SU₀ of each of the blocks BLK0 of the plane 0 and the plane 1, thereby turning on all the source side selection gate transistors SSTr (refer to FIG. 10).

2.2.2.2 Time t2 to Time t3

The sense amplifier unit 3 (a plurality of sense amplifiers) provided in each plane performs a sensing operation between the time t2 and a time t3, and an erase verify operation result of the string unit SU₀ of each plane is held in the sense amplifier unit 3 of the corresponding plane.

2.2.2.3 Time t3 to Time t5

At the time t3, voltages of the drain side selection gate line SGDL and the source side selection gate line SGSL of the string unit SU₀ of each plane are reduced so as to turn off the drain side selection gate transistors SDTr and the source side selection gate transistors SSTr. At a time t4, a voltage of the bit line BL is reduced.

Between the time t3 and the time t4, the sense amplifier unit 3 of each of the plane 0 and the plane 1 reads the erase verify operation result of the string unit SU₀, and the column controller 6 determines erase verify pass or erase verify failure of the string unit SU₀.

Between the time t4 and a time t5, the sequencer 15 controls the bit line BL so as to be charged for the plane which passes the erase verify operation. On the other hand, the sequencer 15 does not charge the bit line BL so as to be maintained at a voltage VSS for the plane which fails in the erase verify operation.

Between the time t3 and the time t4, the column controller 6 determines the erase verify pass or the erase verify failure of the selected string unit SU₀ of each plane, and transmits a result thereof to the sequencer 15. The sequencer 15 holds the erase verify pass or the erase verify failure of the string unit SU₀ in the register 20b.

The register 20b includes areas which can hold data of 1 bit×(the number of string units SU per block BLK)×(the number of planes). The register 20b includes, for example, a first storing area (corresponding to the plane 0; a data area of 1 bitx (the number of string units SU)) and a second storing area (corresponding to the plane 1; a data area of 1 bitx (the number of string units SU)).

The sequencer 15 holds the erase verify pass or the erase verify failure of the string unit SU₀ of the plane 0 in the first storing area, and holds the erase verify pass or the erase verify failure of the string unit SU₀ of the plane 1 in the second storing area.

Since both of the selected string units SU of the plane 0 and the plane 1 pass the erase verify operation, the flow proceeds to step S2-4 and Yes in step S2-5 of FIG. 8. Since both of the erase verify operation results of the plane 0 and the plane 1 indicate the erase verify pass in step S2-5, the sequencer 15 maintains the selected states of both of the planes. In addition, the sequencer 15 determines whether or not j1 is i−1 (step S2-6).

Since j1 is 0, the sequencer 15 increments j1 (step S2-7).

2.2.2.4 Time t5

At the time t5, the sequencer 15 precharges the bit lines BL0 to BLm to the voltage Vbl again for the plane 0 and the plane 1 which pass the erase verify operation. The source line SL is maintained at the voltage Vsl. The word lines WL of the blocks BLK0 of the plane 0 and the plane 1 are maintained at the voltage Vev1.

2.2.2.5 Time t6

At a time t6, the string unit SU₁ is selected from the block BLK0 of each of the plane 0 and the plane 1.

2.2.2.6 Time t6 to Time t7

Between the time t6 and a time t7, the sense amplifier unit 3 provided in each plane performs a sensing operation, and an erase verify operation result of the string unit SU₁ of each plane is held in the corresponding sense amplifier unit 3.

2.2.2.7 Time t7 to Time t9

At the time t7, voltages of the drain side selection gate line SGDL and the source side selection gate line SGSL of the string unit SU₁ of each plane are reduced so as to turn off the drain side selection gate transistors SDTr and the source side selection gate transistors SSTr. At a time t8, a voltage of the bit line BL is reduced.

Between the time t7 and the time t8, the sense amplifier unit 3 of each of the plane 0 and the plane 1 reads the erase verify operation result of the string unit SU′, and the column controller 6 determines erase verify pass or erase verify failure of the string unit SU₁.

Between the time t8 and a time t9, the sequencer 15 controls the bit line BL so as to be charged for the plane which passes the erase verify operation. On the other hand, the sequencer 15 does not charge the bit line BL so as to be maintained at the voltage VSS for the plane which fails in the erase verify operation.

Between the time t7 and the time t8, the column controller 6 determines the erase verify pass or the erase verify failure of the selected string unit SU₁ of each plane, and transmits a result thereof to the sequencer 15. The sequencer 15 holds the erase verify pass or the erase verify failure of the string unit SU₁ in the register 20b.

The sequencer 15 holds the erase verify pass or the erase verify failure of the string unit SU₁ of the plane 0 in the first storing area, and holds the erase verify pass or the erase verify failure of the string unit SU′ of the plane 1 in the second storing area.

The selected string unit SU₁ of the plane 1 passes the erase verify operation, and the selected string unit SU₁ of the plane 0 fails in the erase verify operation. Therefore, in step S2-4, the sequencer 15 sets the plane 0 so as not to be selected in next erase verify operation. Since the selected string unit SU₁ of the plane 1 passes the erase verify operation (Yes in step S2-5), the sequencer 15 determines whether or not j1 is i−1 (step S2-6).

Since j1 is 1, the sequencer 15 increments j1 (step S2-7), and returns to step S2-2.

2.2.2.8 Time t9

At the time t9, the sequencer 15 precharges the bit lines BL0 to BLm to the voltage Vbl again for the plane 1 which passes the erase verify operation. The source line SL is maintained at the voltage Vsl. The word line WL of the block BLK0 of the plane 1 is maintained at the voltage Vev1.

2.2.2.9 Time t10

At a time t10, the string unit SU₂ is selected from the block BLK0 of the plane 1.

2.2.2.10 Time t10 to Time t11

Between the time t10 and a time t11, the sense amplifier unit 3 provided in the plane 1 performs a sensing operation, and an erase verify operation result of the string unit SU₂ of the plane 1 is held in the sense amplifier unit 3 of the corresponding plane.

2.2.2.11 Time t11 to Time t13

At the time t11, voltages of the drain side selection gate line SGDL and the source side selection gate line SGSL of the string unit SU₂ of the plane 1 are reduced so as to turn off the drain side selection gate transistors SDTr and the source side selection gate transistors SSTr. At a time t12, a voltage of the bit line BL is reduced. Between the time t11 and the time t12, the sense amplifier unit 3 of each of the plane 0 and the plane 1 reads the erase verify operation result of the string unit SU₂, and the column controller 6 determines the erase verify pass or the erase verify failure of the string unit SU₂.

Between the time t12 and a time t13, the sequencer 15 controls the bit line BL so as to be charged for the plane which passes the erase verify operation. On the other hand, the sequencer 15 does not charge the bit line BL so as to be maintained at the voltage VSS for the plane which fails in the erase verify operation.

The sense amplifier unit 3 of the plane 1 holds the erase verify operation result of the string unit SU₂ until the time t12 described later. The column controller 6 determines the erase verify pass or the erase verify failure of the selected string unit SU₂ of the plane 1, and transmits a result thereof to the sequencer 15. The sequencer 15 holds the erase verify pass or the erase verify failure of the string unit SU₂ in the register 20b.

Since the selected string unit SU₂ of the plane 1 passes the erase verify operation and j1 is 2, the sequencer 15 increments j1 (step S2-7).

2.2.2.12 Time t13

At the time t13, the sequencer 15 precharges the bit lines BL0 to BLm to the voltage Vbl again for the plane 1 which passes the erasing verify operation. The source line SL is maintained at the voltage Vsl. The word line WL of the block BLK0 of the plane 1 is maintained at the voltage Vev1.

2.2.2.13 Time t14

At a time t14, the string unit SU₃ is selected from the block BLK0 of the plane 1. A voltage relationship or a control method is the same as the voltage relationship or the control method at the times t1, t5 and t9.

2.2.2.14 Time t14 to Time t15

Between the time t14 and a time t15, the sense amplifier unit 3 provided in the plane 1 performs a sensing operation, and erase verify pass or erase verify failure of the string unit SU₃ of the plane 1 is held in the sense amplifier unit 3 of the corresponding plane. A voltage relationship or a control method is the same as the voltage relationship or the control method between the times t2 and t3.

2.2.2.15 Time t15

At the time t15, voltages of the drain side selection gate line SGDL and the source side selection gate line SGSL of the string unit SU₃ of the plane 1 are reduced.

2.2.2.16 Times t15 to t17

The sense amplifier unit 3 of the plane 1 holds the erase verify operation result of the string unit SU₃ until a time t16 described later. The column controller 6 determines the erase verify pass or the erase verify failure of the selected string unit SU₃ of the plane 1, and transmits a result thereof to the sequencer 15. The sequencer 15 holds the erase verify pass or the erase verify failure of the string unit SU₃ in the register 20b.

The erase verify result for the plane 1 is the erase verify failure. For this reason, a recovery operation is performed at a time t17 so as to discharge the voltage Vsl of the source line SL.

2.2.2.17 Time t17 and Thereafter

Since the erase verify result for the plane 1 is the erase verify failure (No in step S2-5), if LOOP1 is not the maximum loop number (step S2-9), the sequencer 15 erases data of the block which is not selected as target of an erase verify operation in step S2-4 and includes the erase verify failure (step S2-10).

2.2.3 Conceptual Diagram of Step S2

The above-described example is summarized as in FIG. 11 when summarized using a conceptual diagram. FIG. 11 is a conceptual diagram illustrating selected blocks of each plane. Each of the selected blocks of the plane 0 and the plane 1 has string units SU. A single rectangle corresponds to a single string unit SU. In FIG. 11, “P” indicates erase verify pass, and “F” indicates erase verify failure.

Erase verify operation is sequentially performed on the string units SU of the plane 0 until erase verify result for selected string unit of plane 0 is determined as being the erase verify failure (“F”). Similarly, Erase verify operation is sequentially performed on the string units SU of the plane 1 until erase verify result for selected string unit of plane 1 is determined as being the erase verify failure (“F”).

2.3 Step S3 to Step S5

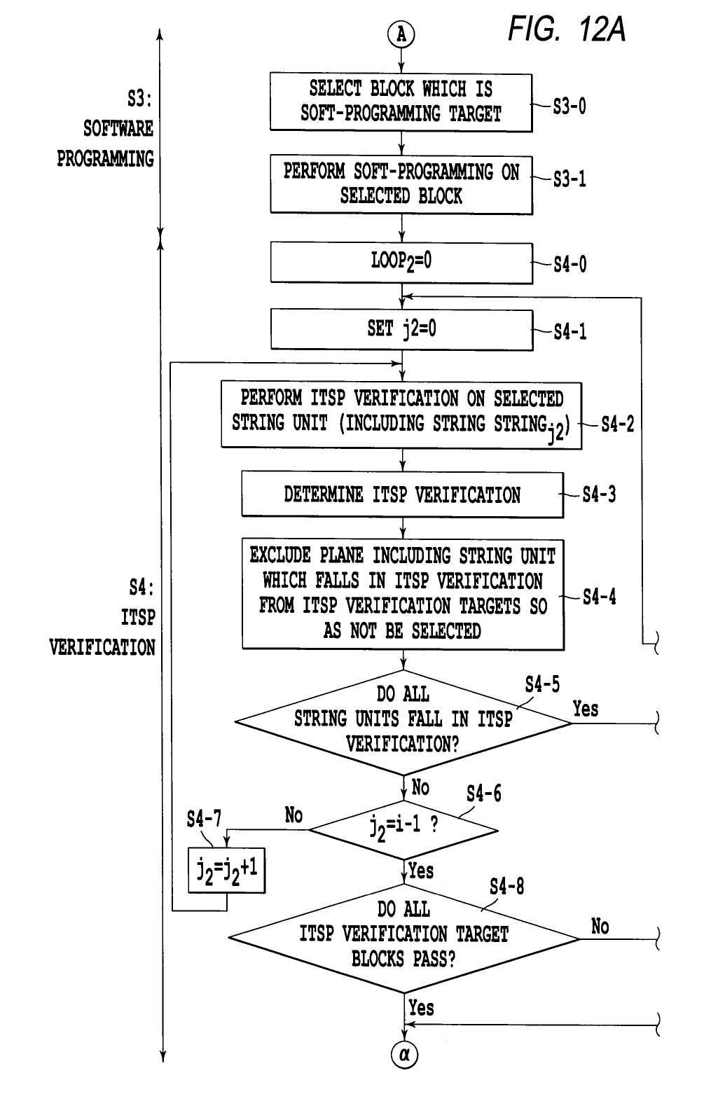

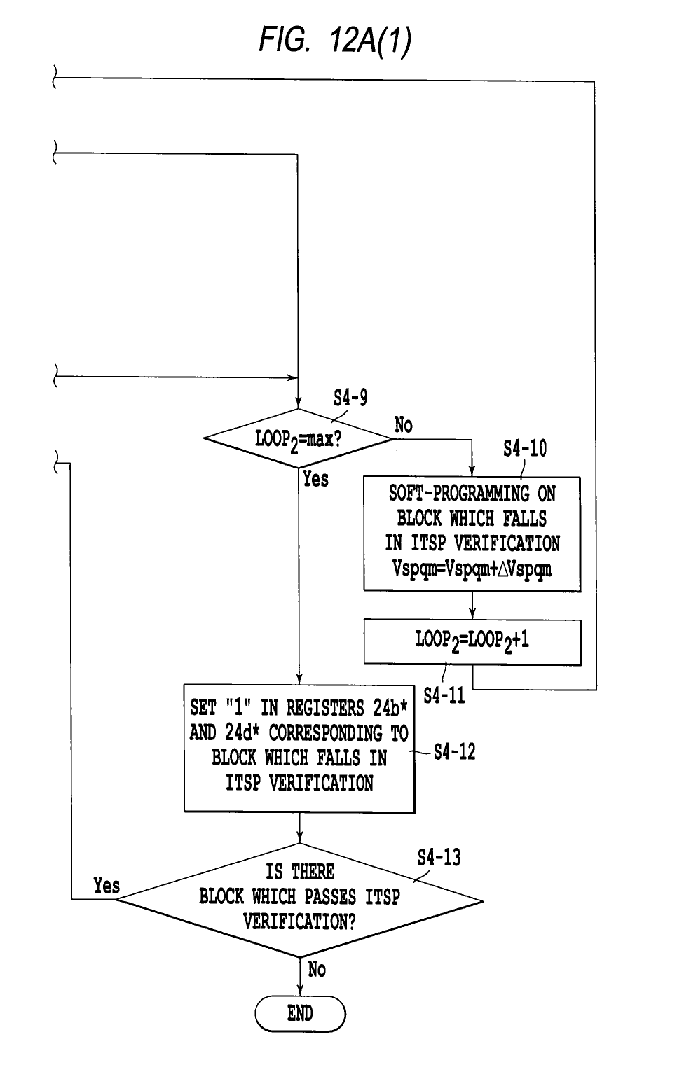

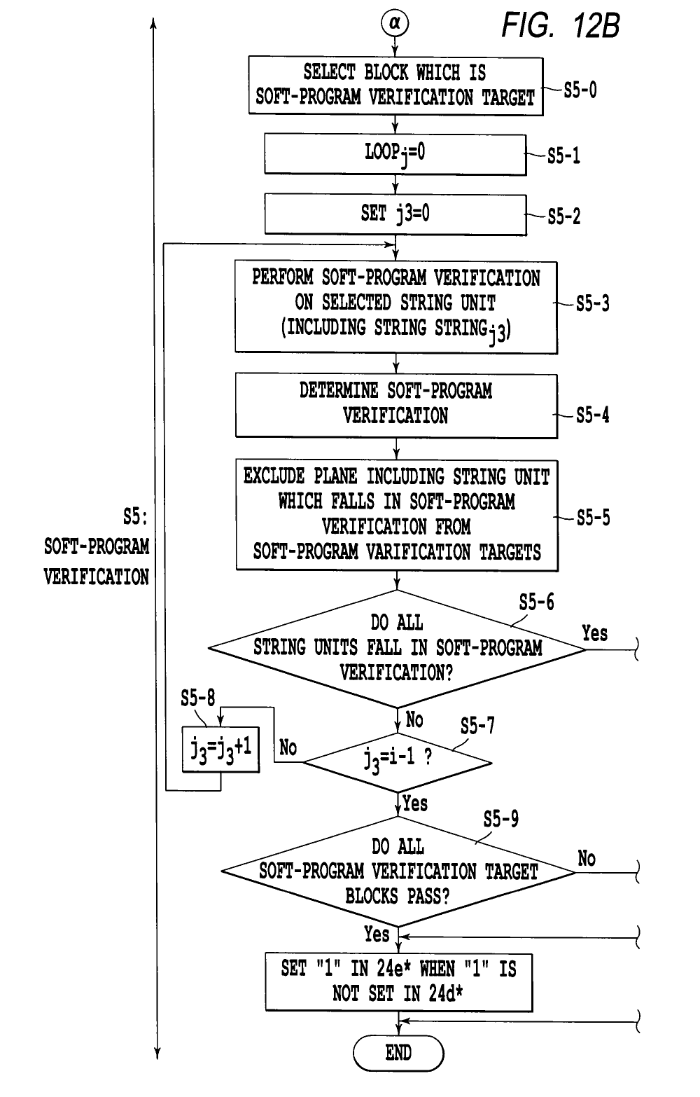

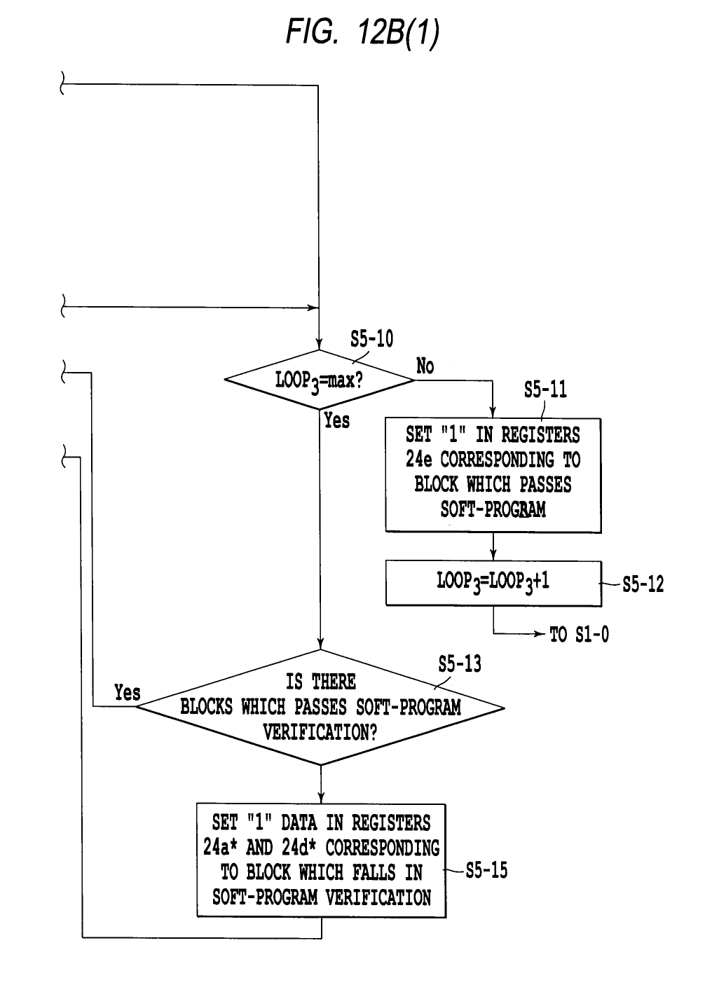

Step S3 to step S5 will be described with reference to flowcharts of FIGS. 12A and 12B.

2.3.1 Step S3

As shown in FIG. 12A, in step S3-0, a block which is a target of soft-programming is selected. Specifically, the sequencer 15 determines whether “1” is set in either of the register 24d0 or the register 24e0 corresponding to the plane 0 and “1” is set in either of the register 24d1 or the register 24e1 corresponding to the plane 1.

The sequencer 15 selects a block BLK of the plane in which “1” is not set in any of the register 24d* (* indicates either of 0 or 1, and this is also the same for the following) and the register 24e*.

In step S3-1, the sequencer 15 performs soft-programming on the block BLK of the plane selected in step S3-0. For convenience of description, a description will be made of an example in which both of the plane 0 and the plane 1 are selected in step S3-0.

In other words, the sequencer 15 collectively performs the soft-programming on a block in which all string units SU in the block BLK pass the erase verify operation in the plane 0 and the plane 1 (step S3-1).

If a threshold voltage of a cell transistor from which data is erased is too lower than a threshold voltage (negative voltage) of a desired erase state, not only cell transistor receives unnecessarily writing voltage but also a writing time increases when data is written thereafter.

Therefore, the soft-programming is performed in order to set the threshold voltage of the cell transistor from which data is erased to the desired erasure state.

All the string units SU₀ to SUᵢ₋₁ of the block BLK0 of the plane 0 and the plane 1 are selected. A desired low voltage (for example, 0 V) is applied to all the bit lines BL0 to BLm so as to apply a voltage for turning off the gates of the source side selection gate transistors SSTr. In addition, a voltage for turning on the gates of the drain side selection gate transistors is applied to the gates of the drain side selection gate transistors SDTr.

Further, a desired voltage (for example, a voltage Vspgm which is about 10 V) is applied to all the word lines WL connected to the string units SU₀ to SUⱼ₋₁ so as to perform the soft-programming.

2.3.2 Step S4

As shown in FIG. 12A, in step S4, the ITSP verify operation is performed for each string unit SU of the selected block BLK. Here, in the ITSP verify operation, it is checked that the number of cell transistors MTr of which a threshold voltage is equal to or higher than a voltage Vitsp is equal to or more than the threshold value X2 in the selected string unit unlike in the erasing verify operation.

This ITSP verify operation is a verify operation for checking whether or not a threshold voltage of the cell transistor is in an over-erasure state relative to a desired erasure state through the soft-programming in step S3.

The threshold value X2 is an empirical value. For example, the threshold value X2 may be set to a value defined based on a correction performance of ECC. The threshold value X2 may be the same value as the threshold value X1, or may be different from the threshold value X1.

In the ITSP verify operation, the sequencer 15 sets LOOP2=0 in step S4-0. In step S4-1, the sequencer 15 sets j2=0. In addition, string units SU_{J2} are selected from the selected blocks BLK (for example, the blocks BLK0 of the plane 0 and the plane 1) of the respective planes, and the ITSP verify operation is performed for each string unit SU 2 (step S4-2). In other words, if a threshold voltage of each cell transistor MTr of the selected string unit SU is lower than the desired voltage Vitsp, a voltage of the bit line BL or a voltage of the sen node is discharged. On the other hand, if the selected string unit SU includes at least one cell transistor MTr of which a threshold voltage is higher than the desired voltage Vitsp, a voltage of the bit line BL or a voltage of the sen node is maintained.

In step S4-3, the column controller 6 determines whether the selected string unit passes the ITSP verify operation or fails in the ITSP verify operation on the basis of a result of the ITSP verify operation in step S4-2 and the threshold value X2.

In step S4-4, the sequencer 15 sets the plane in which the selected string unit SUⱼ₂ fails in the ITSP verify operation so as not to be selected in the second ITSP verify operation.

In step S4-5, the sequencer 15 determines whether or not there is a plane in which the selected string unit SUⱼ₂ is determined as passing the ITSP verify operation. If the selected string unit SU 2 fails in the ITSP verify operation in both of the plane 0 and the plane 1 (Yes in step S4-5), the sequencer 15 proceeds to step S4-9 described later.

If the selected string unit SUⱼ₂ passes the ITSP verify operation in any of the plane 0 and the plane 1 (No in step S4-5), the sequencer 15 determines whether or not j2 is i−1 (step S4-6). If j2 is not i−1 (No in step S4-6), the sequencer 15 increments j2 (step S4-7) and returns to step S4-2 again.

Here, the ITSP verify pass is a verify result when the number of string units SU including at least one cell transistor MTr of which a threshold voltage is equal to or higher than the voltage Vitsp is equal to or more than the threshold value X2.

In addition, the ITSP verify failure is a verify result when the number of string units SU including at least one cell transistor MTr of which a threshold voltage is equal to or higher than the voltage Vitsp is smaller than the threshold value X2.

Voltages applied to the respective lines are different, but detailed operations are the same as in step S4 of FIG. 8, and description thereof will be omitted.

In addition, if the sequencer 15 determines that j2 is i−1 in step S4-6 (Yes in step S4-6), the sequencer 15 determines whether or not all the string units SU pass the ITSP verify operation in the blocks BLK of the plane 0 and the plane 1 selected in step S3-1 (step S4-8). If all the string units SU pass the ITSP verify operation (Yes in step S4-8), the flow proceeds to the next step so as to perform the soft-program verify operation.

On the other hand, if there is a block BLK in which the string unit SU fails in the ITSP verify operation (No in step S4-8), the sequencer 15 determines whether or not LOOP2 (the number of loops) exceeds a threshold value (maximum loop number) (step S4-9).

If LOOP2 (the number of loops) does not exceed the threshold value (the maximum loop number) (No in step S4-9), the sequencer 15 selects again a block BLK including a string unit SU which fails in the ITSP verify operation and performs the soft-programming on the block BLK including the string unit SU which fails in the ITSP verify operation (step S4-10). Here, a programming voltage used for the soft-programming is stepped up.

In step S4-11, the sequencer 15 increments LOOP2 and returns to step S4-2.

If LOOP2 (the number of loops) reaches the threshold value (the maximum loop numer) (Yes in step S4-9), the sequencer 15 sets “1” in the corresponding registers 24b0 and 24d0 when the selected block of the plane 0 fails in the ITSP verify operation. Similarly, the sequencer 15 sets “1” in the corresponding registers 24b1 and 24d1 when the selected block of the plane 1 fails in the ITSP verify operation (step S4-12).

In step S4-13, the sequencer 15 determines whether or not statuses of the plane 0 and the plane 1 are fixed. That is, the sequencer 15 determines whether or not “1” is set in the register 24d0 or the register 24e0 corresponding to the plane 0 and “1” is set in the register 24d1 or the register 24e1 corresponding to the plane 1.

If “1” is set in either of the register 24d0 or the register 24e0 and “1” is set in either of the register 24d1 or the register 24e1, the sequencer 15 finishes the erase operation (end).

In addition, although, in the present embodiment, the soft-programming is performed (step S3), and then the ITSP verify operation is performed, an embodiment is not limited thereto, and the ITSP verify operation may be omitted, and the soft-program verify operation may be performed (step S5) after performing the soft-programming (step S3). Details of the soft-program verify operation will be described later.

2.3.3 Step S5

As shown in FIG. 12B, in step S5, the soft-program verify operation is performed for each string unit SU of the selected block BLK. Here, in the soft-program verify operation, it is checked that the number of strings “String” including at least one cell transistor MTr of which a threshold voltage is higher than a voltage Vsoft is within the threshold value X3 in the selected string unit in the same manner as in the erase verify operation.

This soft-program verify operation is a verify operation for securing a desired erasure state after performing the soft-programming.

The threshold value X3 is an empirical value. For example, the threshold value X3 may be set to a value defined based on a correction performance of ECC. The threshold value X3 may be the same value as the threshold values X1 and X2. In addition, the threshold value X3 may be different from the threshold values X1 and X2.

In step S5-0, a block which is a target of the soft-program verify operation is selected. Specifically, the sequencer 15 determines whether “1” is set in either of the register 24d0 or the register 24e0 corresponding to the plane 0 and “1” is set in either of the register 24d1 or the register 24e1 corresponding to the plane 1.

The sequencer 15 selects a block BLK of the plane in which “1” is not set in any of the register 24d* (* indicates either of 0 or 1, and this is also the same for the following) and the register 24e*.

In the soft-program verify operation, the sequencer 15 sets LOOP3=0 in step S5-1. In step S5-2, the sequencer 15 sets j3=0.

In addition, in step S5-3, the sequencer 15 performs the soft-program verify operation on the block BLK of the plane selected in step S5-0. For convenience of description, a case where both of the plane 0 and the plane 1 are selected in step S5-0 will be described as an example. String units SUᵢ₋₃ are selected from the selected blocks BLK (for example, the blocks BLK0 of the plane 0 and the plane 1) of the respective planes, and the soft-program verify operation is performed for each string unit SUⱼ₃ (step S5-3).

In step S5-4, the column controller 6 determines whether the selected string unit passes the soft-program verify operation or fails in the soft-program verify operation on the basis of a result of the soft-program verify operation in step S5-3 and the threshold value X3.

In step S5-5, the sequencer 15 sets the plane having a block BLK including the string unit SUⱼ₃ which fails in the soft-program verify operation so as not to be selected in the soft-program verify operation until next step S1-1 is performed.

In step S5-6, the sequencer 15 determines whether or not there is a plane in which the selected string unit SUⱼ₃ is determined as passing the soft-program verify operation. If the selected string unit SUⱼ₃ fails in the soft-program verify operation in both of the plane 0 and the plane 1 (Yes in step S5-6), the sequencer 15 proceeds to step S5-10.

If the selected string unit SUⱼ₃ passes the soft-program verify operation in any of the plane 0 and the plane 1 (No in step S5-6), the sequencer 15 determines whether or not j3 is i−1 (step S5-7). If j3 is not i−1 (No in step S5-7), the sequencer 15 increments j3 (step S5-8) and returns to step S5-3 again.

Here, the soft-program verify pass is a verify operation result when the number of string units SU including at least one cell transistor MTr of which a threshold voltage is higher than the voltage Vsoft is equal to or less than the threshold value X3.

In addition, the soft-program verify failure is a verify operation result when the number of string units SU including at least one cell transistor MTr of which a threshold voltage is higher than the voltage Vsoft is greater than the threshold value X3.

Voltages applied to the respective lines are different, but detailed operations are the same as in step S4 of FIG. 8, and description thereof will be omitted.

In addition, if the sequencer 15 determines that j3 is i−1 in step S5-7 (Yes in step S5-7), the sequencer 15 determines whether or not all the string units SU pass the soft-program verify operation in the selected blocks BLK of the plane 0 and the plane 1 (step S5-9). If all the string units SU pass the soft-program verify operation (Yes in step S5-9), the erase operation finishes. On the other hand, if any one string unit SU of the selected block BLK fails in the soft-program verify operation (No in step S5-9), the sequencer 15 determines whether or not LOOP3 (the number of loops) exceeds a threshold value (maximum loop number) (step S5-10).

If LOOP3 (the number of loops) reaches the threshold value (the maximum loop number) (Yes in step S5-10), the sequencer 15 determines whether or not there is a block which passes the soft-program verify operation (step S5-13). If there is no selected block which passes the soft-program verify operation (No in step S5-13), the sequencer 15 sets “1” in the corresponding registers 24c0 and 24d0 when the selected block of the plane 0 fails in the soft-program verify operation (step S5-15). Similarly, the sequencer 15 sets “1” in the corresponding registers 24c1 and 24d1 when the selected block of the plane 1 fails in the soft-program verify operation (step S5-15).

If there is a selected block which passes the soft-program verify operation (Yes in step S5-13), the sequencer 15 fixes statuses of the plane 0 and the plane 1 (step S5-14). If “1” is not set in the register 24d*, the sequencer 15 sets “1” in the register 24e* corresponding to the register 24d*. In addition, the erase operation finishes (end).

If LOOP3 (the number of loops) does not reach the threshold value (the maximum loop number) (No in step S5-10), the sequencer 15 sets “1” in the register 24e* corresponding to the plane including the block which passes the soft-program verify operation (step S5-11).

In addition, in step S5-12, the sequencer 15 increments LOOP3 and returns to step S1-0 again.

### Effects of the First Embodiment

As above, the present embodiment can provide a semiconductor memory device which can secure an erasure state of a cell transistor with higher accuracy.

A case of performing the erase verify operation in the unit of a selected block will be examined as a comparative example. The following two cases are examined.

(1) A case where data is written in ascending or descending order of strings “String”, and data is written in a certain area (first area) of a block and data is not written in the other area (second area).

(2) A case where data is written in ascending or descending order of strings “String”, data is written in overall areas of a block, but ease of data erasure is different in the unit of a string.

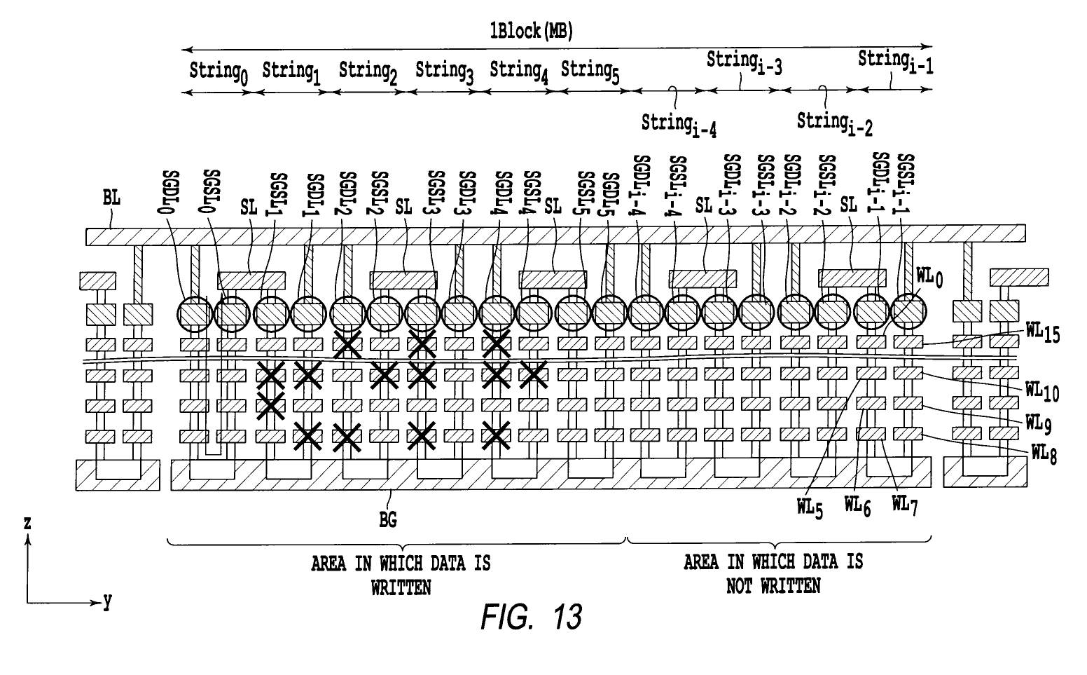

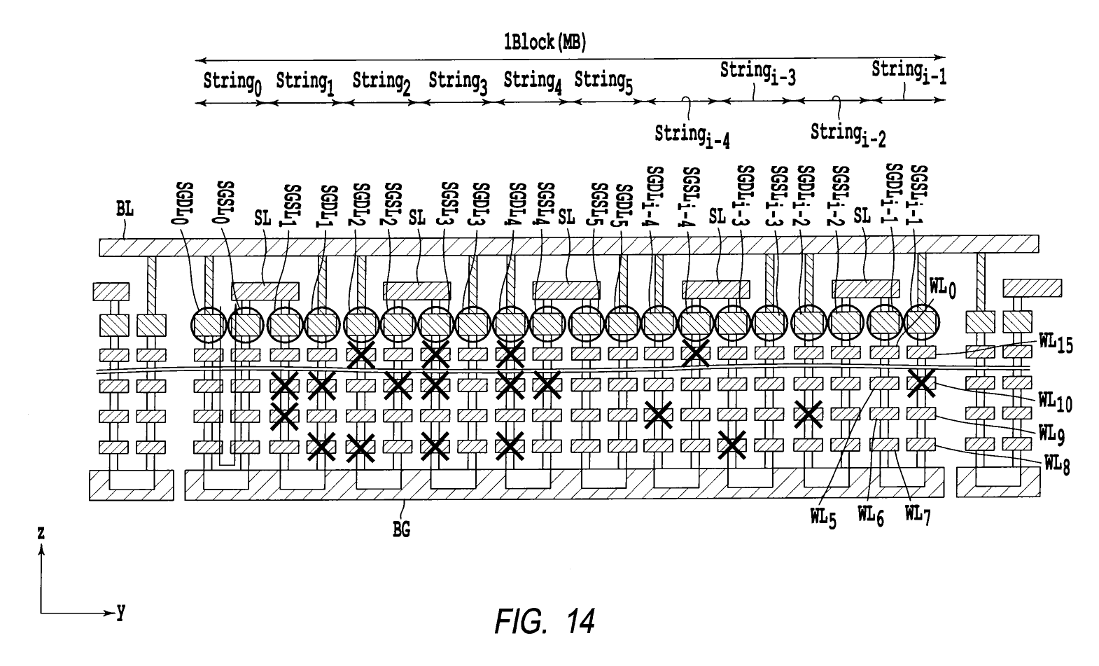

For convenience of description, each of the cases (1) and (2) will be described with reference to FIGS. 13 and 14. FIGS. 13 and 14 show a plurality of strings String₀ to Stringᵢ₋₁ connected to any one of the bit lines BL.

It is assumed that erasure for a plurality of cell transistors is not completed in the strings String₀ to Stringᵢ₋₁. In FIGS. 13 and 14, the cell transistors denoted by “x” indicate cell transistors for which erasure is not completed.

I Case (1)

In a comparative example, the erase verify operation is performed in the unit of a block, and thus all the drain side selection transistors SDTr and all the source side selection transistors SSTr of the strings String₀ to Stringᵢ₋₁ are collectively turned on. Thereby, all the string units SU₀ to SUᵢ₋₁ of the selected blocks BLK of the plane 0 and the plane 1 are selected.

If the erase verify operation is performed in this state, the string “String” of the second area in which data is not written is already in an erasure state. Therefore, a voltage of the bit line BL of a voltage of the sen node in the sense amplifier unit is discharged via the string (the string Stringᵢ₋₁ of FIG. 13), and thus the string “String” passes the erase verify operation. In other words, there are cases where the erase verify operation is not performed on the first area in which data is written, and thus an erasure state of the cell transistors cannot be secured.

In addition, there are cases where it cannot be discriminated whether or not the first area includes cell transistors with poor cells, and it cannot be determined whether or not the cell transistors can be used.

However, in the present embodiment, the erase verify operation is performed for each of string units SU₀ to SUᵢ₋₁. For this reason, even if there is a string “String” of the second area in which data is not written, a string “String” of the first area in which data is written is selected and undergoes the erase verify operation, and thus an erasure state of the cell transistors of the first area can be secured.

In addition, since the erase verify operation is performed for each of the string units SU₀ to SUᵢ₋₁ in the present embodiment, it can be discriminated whether or not a string includes cell transistors with poor cells. As a result, an area which can be used as data can also be determined. The sequencer 15 can discriminate, for example, a string including a cell transistor with an acquired poor cell and thus can also change a data area.

II Case (2)

In FIG. 14, a case where ease of data erasure of the string String₀ and ease of data erasure of the string Stringᵢ₋₃ are different will be examined.

In a comparative example, the erase verify operation is performed in the unit of a block, and thus all the drain side selection transistors SDTr and all the source side selection transistors SSTr of the strings String₀ to Stringᵢ₋₁ are collectively turned on. Thereby, all the string units SU₀ to SUᵢ₋₁ of the selected blocks BLK of the plane 0 and the plane 1 are selected.

If the erase verify operation is performed in this state, there are cases where a voltage of the bit line BL or voltage of the sen node is discharged via the string String₀, and thus the string Stringᵢ₋₄ passes the erase verify operation even if erasure of data thereof is in an insufficient state. In other words, there are cases where an erasure state of the cell transistors of the string Stringᵢ₋₄ cannot be secured.

However, in the present embodiment, the erase verify operation is performed for each of the string units SU₀ to SUᵢ₋₁. For this reason, an erasure state of the cell transistors of the string Stringᵢ₋₄ can be secured.

In addition, since the erase verify operation is performed for each of the string units SU₀ to SUᵢ₋₁ in the present embodiment, it can be discriminated whether or not a string includes cell transistors with poor cells. As a result, an area which can be used as data can also be determined. The sequencer 15 can discriminate, for example, a string including a cell transistor with an acquired poor cell and thus can also change a data area.

### Second Embodiment

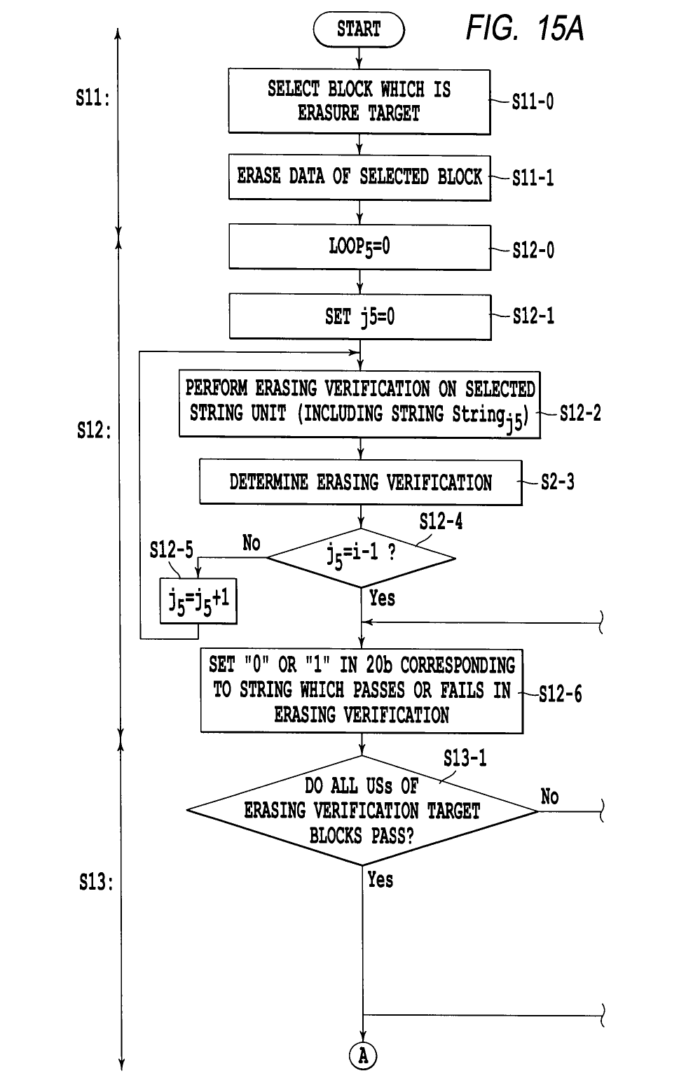

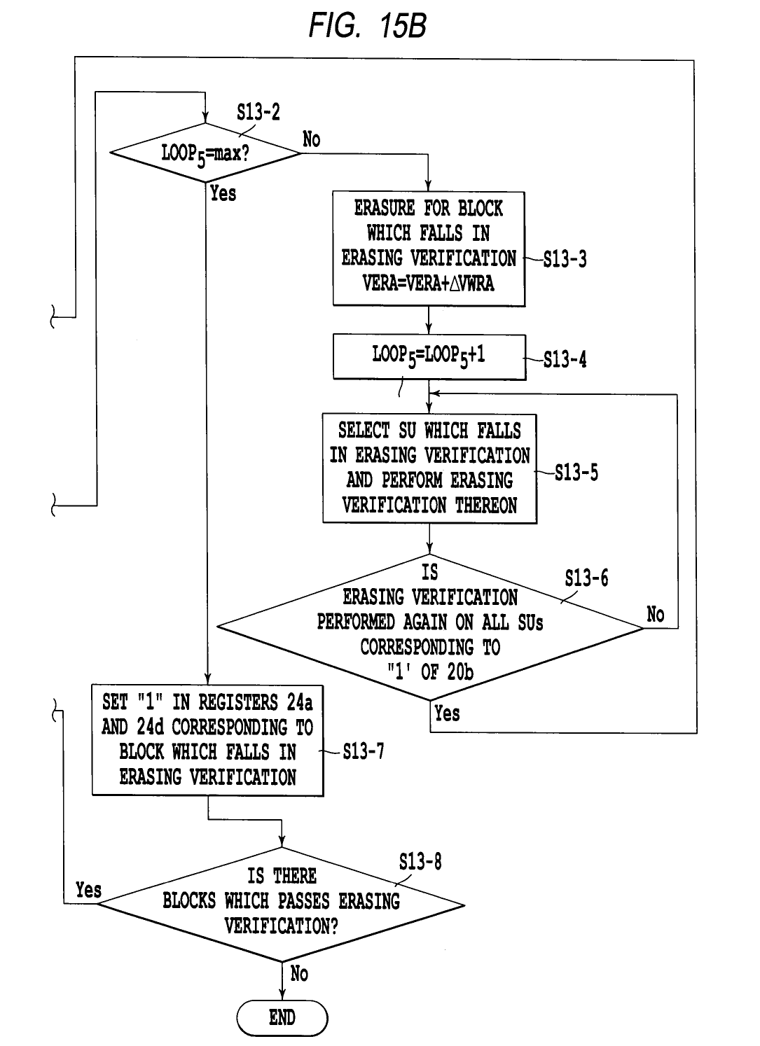

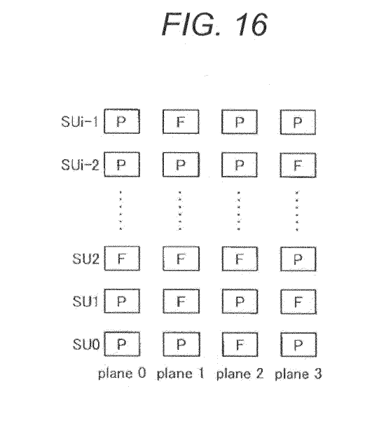

Next, a semiconductor memory device according to the second embodiment will be described with reference to a flowchart of FIG. 15 and a conceptual diagram of FIG. 16. The semiconductor memory device according to the second embodiment is different from the semiconductor memory device according to the first embodiment in an erase operation, and other configurations of the semiconductor memory device are the same as in the first embodiment.

An erasing operation of the semiconductor memory device according to the present embodiment will be described with reference to FIGS. 15 and 16. FIG. 15 shows an example of the operation of the sequencer 15.

3. Outline of the Erase Operation

The erase operation according to the present embodiment includes the erase verify operation for each string unit of a selected block after data is erased for the selected block. The erase operation according to the second embodiment is different from the erase operation according to the first embodiment in that the erase verify operation is performed on the next string unit SU regardless of an erase verify result of the string unit SU.

The erase operation according to the present embodiment includes soft-programming for a selected block, the ITSP verify operation for each string unit, and the soft-program verify operation for each string unit, after the erase verify operation is performed.

For convenience of description, only the erase verify operation will be described. The ITSP verify operation or the soft-program verify operation is performed through the same steps as the steps of the erase verify operation.

In addition, although, in the present embodiment, the ITSP verify operation and the soft-program verify operation are performed for each string unit, an embodiment is not limited thereto, and the ITSP verify operation and the soft-program verify operation may be collectively performed on a selected block.

FIG. 15 is a flowchart illustrating the erase operation according to the second embodiment. In the present embodiment, it is assumed that there are four planes (planes 0 to 3), and each plane includes i string units SU.

The erase operation according to the present embodiment largely includes two steps. In step SS1, the erase verify operation is performed on all string units SU of a selected block BLK. In addition, in step SS2, after the second erase operation is performed, a string unit SU which fails in the erase verify operation is selected from each plane and undergoes the erase verify operation individually.

Step SS1 includes steps S11-1 to S12-6. Further, step SS2 includes steps S13-1 to S15-1.

3.1 Step S11

First, in step S11-0, a block which is an erasure target is selected. Specifically, the sequencer 15 sets, as blocks which are erasure targets, a block which is selected by the block address signal BLKADD0 and in which “1” is not set in any of the registers 24a0 to 24e0 from the plane 0, and a block which is selected by the block address signal BLKADD1 and in which “1” is not set in any of the registers 24a1 to 24e1 from the plane 1. This is also the same for the planes 2 and 3.

In step S11-1, data of the memory cell of the block selected in step S11-0 is erased.

Specifically, the sequencer 15 receives a command and addresses (a block address, a string unit address, and the like) and starts to execute step S11. The sequencer 15 supplies the block address signals BLKADD0 to BLKADD3 to the row decoder 5, and supplies the string unit address signals SUADD0 to SUADD3 and the word line address signal WLADD to the driver 13.

The block address signal BLKADD0 is an address indicating a block selected in the plane 0. The block address signal BLKADD1 is an address indicating a block selected in the plane 1. The block address signal BLKADD2 is an address indicating a block selected in the plane 2. The block address signal BLKADD3 is an address indicating a block selected in the plane 3.

The string unit address signal SUADD0 is an address indicating a string unit SU selected in the plane 0. The string unit address signal SUADD1 is an address indicating a string unit SU selected in the plane 1. The string unit address signal SUADD2 is an address indicating a string unit SU selected in the plane 2. The string unit address signal SUADD3 is an address indicating a string unit SU selected in the plane 3.

For convenience of description, a description will be made of an example in which the block BLK0 of each of the planes 0 to 3 is selected by the block address signals BLKADD0 to BLKADD3 in the erase operation according to the present embodiment.

3.2 Step S12

3.2.1 Flow of Step S12

Next, in step S12, the erase verify operation is performed for each string unit SU selected in each plane.

The sequencer 15 sets LOOP5=0 in step S12-0. In addition, LOOP5 may have a value different from LOOP2 to LOOP4 described above. Further, the sequencer 15 sets j5=0 in step S12-1. The reference sign j5 specifies a string unit.

In step S12-2, the sequencer 15 selects string units SU_{SS} including strings Stringⱼ₅ in the plane 0 to the plane 3 by using the string unit address signals SUADD0 to SUADD3 supplied by the driver 13.

In step S12-3, the column controller 6 counts the number of “1” data (erase verify failure) from the result of the erase verify operation in step S12-2, and holds data indicating the number of “1” data in the register 6a. In addition, the column controller 6 reads a threshold value held in the register 20a of the sequencer 15. That is, the sequencer 15 transmits the threshold value X1 corresponding to the erase verify operation to the register 6b of the column controller 6, and the column controller 6 holds the threshold value X1 in the register 6b. The column controller 6 determines whether or not the selected string unit SUⱼ₅ passes the erase verify operation or fails in the erase verify operation on the basis of the data indicating the number of “1” data and the threshold value X1.

In step S12-4, the sequencer 15 determines whether or not j 5 is i−1. If j 5 is not i−1 (No in step S12-4), the sequencer 15 increments j5 (step S12-5), and returns to step S12-2.

On the other hand, if j5 is i−1 (Yes in step S12-4), the sequencer 15 sets “0” data in the register 20b corresponding to a string unit SU which passes the erase verify operation in each of the selected blocks BLK of the plane 0 to the plane 3, and sets “1” data in the register 20b corresponding to a string unit SU which fails in the erase verify operation. Here, “1” data is data indicating that the string unit SU fails in the erase verify operation (step S12-6).

In addition, the sequencer 15 determines whether or not all the string units SU of the block BLK which is an erasure target pass the erase verify operation (step S13-1). Specifically, the sequencer 15 reads the register 20b corresponding to each string unit SU, and determines whether or not there is a string unit SU in which “1” data is set.

If all the string units SU pass the erase verify operation (Yes in step S13-1), the erase verify operation finishes so as to perform soft-programming.

On the other hand, if all of the string units SU do not pass the erase verify operation (No in step S13-1), that is, any one of the string units SU fails in the erase verify operation, the sequencer 15 determines whether or not LOOP5 (the number of loops) exceeds a threshold value (the maximum loop number) (step S13-2).

If LOOP5 (the number of loops) does not reach the threshold value (the maximum loop number) (No in step S13-2), the sequencer 15 selects again a block BLK including a string unit SU which fails in the erase verify operation so as to erase data of the block BLK again (step S13-3). Here, an erasing voltage (for example, 20 V) used for the erase operation is stepped up.

The sequencer 15 increments LOOP5 (step S13-4), and selects again the string unit SU which fails in the erase verify operation of the block BLK selected in step S13-3 so as to perform the erase verify operation (step S13-5).

In other words, the string unit SU which fails in the erase verify operation is selected from each of the plane 0 to the plane 3, and the erase verify operation is performed only on the selected string unit SU.

In step S13-6, the sequencer 15 determines whether or not the erase verify operation is performed on all the string units SU which fail in the erase verify operation in each of the plane 0 to the plane 3. If all the string units SU which fail in the erase verify operation in step S13-1 do not undergo the erase verify operation in step S13-5 (No in step S13-6), the sequence 15 returns to step S13-5, and a string unit SU which does not undergo the erase verify operation in previous step S13-5 is selected and undergoes the erase verify operation.

If all the string units SU which fail in the erase verify operation in step S13-1 undergo the erase verify operation in step S13-5 (Yes in step S13-6), the sequencer 15 returns to step S12-6.

If LOOP5 (the number of loops) reaches the threshold value (the maximum loop number) (Yes in step S13-2), when there are string units SU which fail in the erase verify operation in the selected blocks of the plane 0 to the plane 3, the sequencer 15 sets “1” in the registers 24a0 to 24a3 and 24d0 to 24d3 corresponding to the planes including the blocks (step S13-7). In step S13-8, the sequencer 15 determines whether or not the selected block BLK passes the erase verify operation.

If any of the blocks BLK of the plane 0 to the plane 3 pass the erase verify operation (Yes in step S13-8), the erase verify operation finishes so as to perform soft-programming.

If all the blocks BLK of the plane 0 to the plane 3 fail in the erase verify operation (No in step S13-8), the erase verify operation finishes without performing the soft-programming.

FIG. 16 is a schematic diagram illustrating data which is held in the register 20b in a state of Yes in step S12-4. In FIG. 16, a state in which “0” data is set in the register 20b described with reference to FIG. 15 is indicated by “P”, and a state in which “1” data is set therein is indicated by “F”.

Thereby, the sequencer 15 can discriminate erase verify pass or erase verify failure of each of the string units SU₀ to SUᵢ₋₁ in the selected blocks of the planes 0 to 3.

In step S12-6, the sequencer 15 sets “1” data in the register 20b corresponding to a string unit SU which fails in the erase verify operation in each of the planes 0 to 3.

In FIG. 16, the sequencer 15 extracts the string units SU of “F”. In the plane 0, a string unit SU of “F” is the string unit SU₂. In the plane 1, string units SU of “F” are the string unit SUₗ, the string unit SU₂, . . . , and the string unit SUᵢ₋₁. In the plane 2, string units SU of “F” are the string unit SU₀, the string unit SU₂, . . . . In the plane 3, string units SU of “F” are the string unit SU₂, . . . , and a string unit SUᵢ₋₂.

In FIG. 16, since there are one or more string units SU which fail in the erase verify operation in each of the planes 0 to 3, the flow proceeds to No in step S13-1.

In addition, if LOOP5 (the number of loops) does not reach the threshold value (the maximum loop number) (No in step S13-2), there are one or more string units SU which fail in the erase verify operation in each of the planes 0 to 3, and thus the sequencer 15 erases data of blocks selected in all the planes 0 to 3 again (step S13-3).

The sequencer 15 increments LOOP5 (step S13-4), and selects the string unit SU₂ of the plane 0, the string unit SU₁ of the plane 1, the string unit SU₀ of the plane 2, and the string unit SU₁ of the plane 3, so as to perform the erase verify operation (step S13-5). The string unit address signal is changed for each of the planes 0 to 3, and different string units SU can be selected in the planes 0 to 3.

The sequencer 15 repeatedly performs step S13-5 until the erase verify operation is performed on all the string units SU of “F” in the selected block BLK for each of the planes 0 to 3 (No in step S13-6). If the erase verify operation is performed on all the string units SU of “F” (Yes in step S13-6), the sequencer 15 returns to step S12-6, and updates the corresponding register 20b on the basis of erase verify pass or erase verify failure information of each string unit in step S13-5.

### Effects of Second Embodiment

As above, the present embodiment can provide a semiconductor memory device which can secure an erasure state of a cell transistor with higher accuracy in the same manner as the first embodiment.

In the present embodiment, it is possible to perform an erase operation in a short time as compared with the first embodiment. Details thereof will be described.

In the first embodiment, for example, the erase verify operation is performed in ascending or descending order of the string units SU at all times. The erase verify operation is performed on the string unit SU₀, the erase verify operation is performed on the string unit SU₁, . . . , and the erase verify operation is performed on the string unit SUᵢ.

It is assumed that the following erase verify operation result is obtained through the initial erase verify operation.

It is assumed that the string unit SU₀ of the plane 0 fails in the erase verify operation. On the other hand, it is assumed that the string unit SU₀ of the plane 1 passes the erase verify operation, and the string unit SU₁ thereof fails in the erase verify operation.

In this case, the next erase operation is performed, and the string unit SU₀ of the plane 0 fails in the erase verify operation when next erase verify operation is performed. Therefore, it is necessary to perform again the erase verify operation on the string unit SU₀ of each of the plane 0 and the plane 1.

In other words, in the first embodiment, the order of the string units is common to the plane 0 and the plane 1, and thus the erase verify operation is performed again even on the string unit SU₀ which passes the erase verify operation.

However, in the second embodiment, a string unit SU which fails in the erase verify operation is selected and undergoes the erase verify operation again, and thus it is possible to reduce the number of the erase verify operations to be performed. As a result, in the second embodiment, it is possible to shorten an erase operation as compared with the first embodiment.

In addition, the present disclosure is not limited to the above-described embodiments and may have various modifications without departing from the spirit thereof in the implementation stage. In both of the embodiments of the present specification, the erase verify operation, the ITSP verify operation, and the soft-program verify operation are applied to all string units SU in a selected block BLK, but the present disclosure is not limited thereto, and, for example, the erase verify operation, the ITSP verify operation, and the soft-program verify operation may be applied only to a plurality of predetermined string units SU of a selected block BLK. Specifically, for example, if the erase verify operation is performed only on the string units SU_{E}) to SU₃, the sequencer 15 determines whether or not j1 is 3 in step S2-6 of FIG. 8.

The plurality of predetermined string units SU are not limited to a case where the string units are continuously located, and may be a plurality of string units SU which are randomly defined.

Further, the embodiments include solution of various steps, and thus various solution can be extracted through appropriate combinations of a plurality of disclosed constituent elements. For example, in a case where the problems described in problems to be solved by the disclosure can be solved and the effects described in Effects of the disclosure may be achieved even if some constituent elements are deleted from the overall constituent elements shown in the embodiments, a configuration in which the constituent elements are deleted may be extracted as a solution.

A configuration of the memory cell array is disclosed in U.S. patent application Ser. No. 12/407,403, filed on Mar. 19, 2009, entitled “three-dimensional stacked nonvolatile semiconductor memory”. In addition, a configuration thereof is disclosed in U.S. patent application Ser. No. 12/406,524, filed on Mar. 18, 2009, entitled “three-dimensional stacked nonvolatile semiconductor memory”, U.S. patent application Ser. No. 12/679,991, filed on Mar. 25, 2010, entitled “nonvolatile semiconductor memory device and manufacturing method thereof”, and U.S. patent application Ser. No. 12/532,030, filed on Mar. 23, 2009, entitled “semiconductor memory and manufacturing method thereof”. The entire contents of the above-identified Patent Applications are incorporated by reference in the present application.

(Appendix 1)

A semiconductor memory device including string units that include a plurality of memory cells stacked on a semiconductor substrate; and a control circuit that erases data of the memory cells in the unit of a block including the plurality of string units and performs erasing verify operation on the memory cell in the unit of the string unit.

(Appendix 2)

The semiconductor memory device according to Appendix 1, wherein the control circuit repeatedly performs the erasing operation and the erasing verify operation until the erase verify operation is passed; performs a first write operation on the memory cell of the block in the unit of the block, performs a first verify operation in which a first voltage is applied to a word line connected to the memory cell of the string unit in the unit of the string unit, and performs a second verify operation in which a second voltage lower than the first voltage is applied to the word line connected to the memory cell of the string unit in the unit of the string unit, after the erase verify operation is passed; and repeatedly performs the first write operation, the first verify operation operation, and the second verify operation until the first verify operation and the second verify operation are passed.

(Appendix 3)

The semiconductor memory device according to Appendix 1 or 2, further including a first plane that includes the plurality of string units; and a second plane that includes the plurality of string units and can be operated independently from the first plane, wherein the control circuit repeatedly performs the erasing operation and the erase verify operation until the erasing verify operation is passed, and wherein, when the control circuit performs the erase verify operation on the string units of the first plane in ascending or descending order of the string units, and performs the erase verify operation on the string units of the second plane in ascending or descending order of the string units, the erase verify operation is collectively performed on the string units of the first plane and the second plane.

(Appendix 4)

The semiconductor memory device according to Appendix 3, wherein, when the control circuit holds a result of the erase verify operation on the string units of the first plane and the second plane, and then performs the erase verify operation on the string units of the first plane and the second plane again, the control circuit selects a string unit which fails in the erase verify operation in the first plane and a string unit which fails in the erase verify operation in the second plane, and performs the erase verify operation on the selected string units again.

(Appendix 5)

The semiconductor memory device according to any one of Appendixes 1 to 4, wherein the block includes m (where m is a natural number) string units, and wherein the control circuit performs the erasing verify operation on n (where n is a natural number; n<m) string units among the m string units.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
string units including a plurality of memory cells stacked above a semiconductor substrate; and
a control circuit configured to perform an erase operation per a block, the block including the string units, the control circuit being configured to perform an erase verify operation per string unit.

2. The semiconductor memory device according to claim 1, wherein the control circuit repeatedly performs the erase operation and the erase verify operation until the erase verify operation is passed.

3. The semiconductor memory device according to claim 2, wherein the control circuit performs a first writing operation for the memory cells in the block after the erase verify operation is passed, the control circuit being configured to perform a first verify operation per string unit on the condition that a first voltage is applied to a word line connected to the memory cell of the string unit, the control circuit being configured to perform a second verify operation per string unit on the condition that a second voltage lower than the first voltage is applied to the word line.

4. The semiconductor memory device according to claim 3, wherein the control circuit repeatedly performs the first writing operation, the first verify operation, and the second verify operation until the first verify operation and the second verify operation are passed.

5. The semiconductor memory device according to claim 1, further comprising:
a first plane including a plurality of string units; and
a second plane including a plurality of string units,
wherein the control circuit is configured to control the first plane and the second plane individually.

6. The semiconductor memory device according to claim 4, further comprising:
a first plane including a plurality of string units; and
a second plane including a plurality of string units,
wherein the control circuit is configured to control the first plane and the second plane individually.

7. The semiconductor memory device according to claim 5, wherein the control circuit is configured to perform the erase verify operation for string unit of the first plane together with string unit of the second plane in order.

8. The semiconductor memory device according to claim 6, wherein the control circuit is configured to perform the erase verify operation for string unit of the first plane together with string unit of the second plane in order.

9. The semiconductor memory device according to claim 7, wherein, when the control circuit holds a result of the erase verify operation for the string units of the first plane and the second plane, and then performs the erase verify operation for the string units of the first plane and the second plane again, the control circuit is configured to performs the erase verify operation on the condition that the control circuit selects a string unit which fails in the erase verify operation in the first plane and a string unit which fails in the erase verify operation in the second plane.

10. The semiconductor memory device according to claim 8, wherein, when the control circuit holds a result of the erase verify operation for the string units of the first plane and the second plane, and then performs the erase verify operation for the string units of the first plane and the second plane again, the control circuit is configured to performs the erase verify operation on the condition that the control circuit selects a string unit which fails in the erase verify operation in the first plane and a string unit which fails in the erase verify operation in the second plane.

11. The semiconductor memory device according to claim 1, wherein the block includes m (where m is a natural number) string units, and
wherein the control circuit performs the erase verify operation on n (where n is a natural number; n<m) string units among the m string units.

12. The semiconductor memory device according to claim 9, wherein the block includes m (where m is a natural number) string units, and
wherein the control circuit performs the erase verify operation on n (where n is a natural number; n<m) string units among the m string units.

13. The semiconductor memory device according to claim 10, wherein the block includes m (where m is a natural number) string units, and
wherein the control circuit performs the erase verify operation on n (where n is a natural number; n<m) string units among the m string units.
